(19) United States
(12) Patent Application Publication
(10) Pub. No.: US 2005/0227871 A1
(43) Pub. Date: Oct. 13, 2005

(54) Herbicidal composition comprising phenylpropynyloxypyridine compounds

(76) Inventors: Jurgen Schaetzer, Basel (CH); Jean Wenger, Basel (CH); Roger Graham Hall, Basel (CH); Kurt Nebel, Basel (CH); Stephen Hole, Stein (CH); Andre Stoller, Basel (CH)

Correspondence Address: SYNGENTA CROP PROTECTION , INC.;PATENT AND TRADEMARK DEPARTMENT, 410 SWING ROAD, GREENSBORO, NC, 27409, US

(21) Appl. No.: 10/510,224

(22) PCT Filed: Apr. 2, 2003
(86) PCT No.: PCT/EP03/03471

§ 371 Date: Apr. 29, 2005

(30) Foreign Application Priority Data
Apr. 3, 2002 (CH) 559/02

(51) Int. Cl. A01N 43/40

(52) U.S. Cl. 504/130

(57) ABSTRACT

Herbicidal composition that, in addition to comprising customary inert formulation adjuvants, comprises a) a compound of formula (I), wherein the substituents R₁, R₂, R₃ and R₄, and the suffixes n and m are as defined in claim 1, or an agronomically acceptable salt of that compound, and b) a synergistically effective amount of one or more co-herbicides. The compositions according to the invention may also comprise a safener.

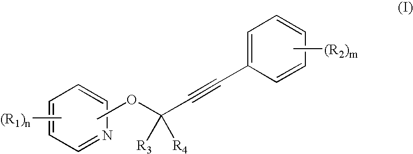

The present invention relates to a novel herbicidal composition comprising a herbicidal active ingredient combination that is suitable for the selective control of weeds in crops of useful plants, for example in crops of cotton, soybeans, sugar beet, sugar cane, plantation crops, rape and, especially, cereals, rice and maize. The invention relates also to a method of controlling weeds in crops of useful plants and to the use of the novel composition for that purpose.

The compounds of formula I 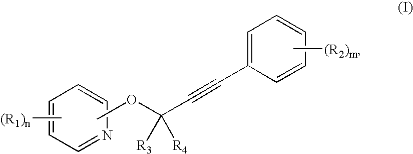
wherein the substituents R₁ to R₄, and the suffixes n and m, are as defined hereinbelow, exhibit herbicidal action.

The compounds of formula I and their preparation are known, for example, from WO 02/28182.

Surprisingly, it has now been found that a combination of variable amounts of active ingredients, that is to say a compound of formula I together with one or more of the herbicidal active ingredients indicated below, which are known and some of which are also commercially available, exhibits a synergistic action that is capable of controlling, both pre-emergence and post-emergence, the majority of weeds occurring especially in crops of useful plants.

There is therefore proposed in accordance with the present invention a novel synergistic composition for the selective control of weeds which, in addition to comprising customary inert formulation adjuvants, comprises as active ingredient a mixture of
a) a herbicidally effective amount of a compound of formula I 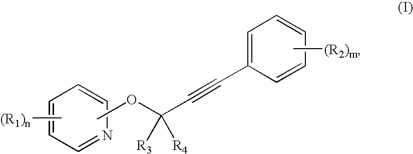
   wherein
n is 0, 1, 2, 3 or 4;
each R₁ independently is halogen, —CN, —SCN, —SF₅, —NO₂, —NR₅R₆, —CO₂R₇, —CONR₈R₉, —C(R₁₀)═NOR₁₁, —COR₁₂, —OR₁₃, —SR₁₄, —SOR₁₅, —SO₂R₁₆, —OSO₂R₁₇, C₁-C₈alkyl, C₂-C₈alkenyl, C₂-C₈alkynyl or C₃-C₆cycloalkyl; or is C₁-C₈alkyl, C₂-C₈alkenyl or C₂-C₈alkynyl mono- or poly-substituted by halogen, —CN, —NO₂, —NR₁₈R₁₉, —CO₂R₂₀, —CONR₂₁R₂₂, —COR₂₃, —C(R₂₄)═NOR₂₅, —C(S)NR₂₆R₂₇, —C(C₁-C₄alkylthio)=NR₂₈, —OR₂₉, —SR₃₀, —SOR₃₁, —SO₂R₃₂ or by C₃-C₆cycloalkyl; or
each R₁ is C₃-C₆cycloalkyl mono- or poly-substituted by halogen, —CN, —NO₂, —NR₁₈R₁₉, —CO₂R₂₀, —CONR₂₁R₂₂, —COR₂₃, —C(R₂₄)═NOR₂₅, —C(S)NR₂₆R₂₇, —C(C₁-C₄alkylthio)=NR₂₈, —SR₃₀, —SOR₃₁, —SO₂R₃₂ or by C₃-C₆cycloalkyl; or
each R₁ independently is phenyl, which may in turn be mono- or poly-substituted by halogen, C₁-C₄alkyl, C₁-C₄haloalkyl, C₁-C₄alkoxy, —CN, —NO₂, C₁-C₄alkylthio, C₁-C₄alkylsulfinyl or by C₁-C₄alkylsulfonyl; or
two adjacent R₁ substituents together form a C₁-C₇alkylene bridge which may be interrupted by 1 or 2 non-adjacent oxygen atoms and substituted by C₁-C₆alkyl, the total number of ring atoms being at least 5 and at most 9; or two adjacent R₁ substituents together form a C₂-C₇alkenylene bridge which may be interrupted by 1 or 2 non-adjacent oxygen atoms and substituted by C₁-C₆alkyl, the total number of ring atoms being at least 5 and at most 9;
R₃ and R₄ are each independently of the other hydrogen, halogen, —CN, C₁-C₄alkyl or C₁-C₄alkoxy; or
R₃ and R₄ together are C₂-C₅alkylene;
R₅ is hydrogen or C₁-C₈alkyl;
R₆ is hydrogen, C₁-C₈alkyl, C₃-C₈alkenyl, C₃-C₈alkynyl, phenyl or benzyl; it being possible for phenyl and benzyl in turn to be mono- or poly-substituted by halogen, C₁-C₄alkyl, C₁-C₄halo-alkyl, C₁-C₄alkoxy, —CN, —NO₂, C₁-C₄alkylthio, C₁-C₄alkylsulfinyl or by C₁-C₄alkylsulfonyl; or
R₅ and R₆ together are a C₂-C₅alkylene chain which may be interrupted by an oxygen or sulfur atom;
R₇ is hydrogen, C₁-C₈alkyl, C₃-C₈alkenyl or C₃-C₈alkynyl, or is C₁-C₈alkyl, C₃-C₈alkenyl or C₃-C₈alkynyl mono- or poly-substituted by halogen, C₁-C₄alkoxy or by phenyl, it being possible for phenyl in turn to be mono- or poly-substituted by halogen C₁-C₄alkyl, C₁-C₄halo-alkyl, C₁-C₄alkoxy, —CN, —NO₂, C₁-C₄alkylthio, C₁-C₄alkylsulfinyl or by C₁-C₄alkylsulfonyl;
R₈ is hydrogen or C₁-C₈alkyl;
R₉ is hydrogen or C₁-C₈alkyl, or is C₁-C₈alkyl mono- or poly-substituted by COOH, C₁-C₈-alkoxycarbonyl or by —CN, or
R₉ is C₃-C₈alkenyl, C₃-C₈alkynyl, phenyl or benzyl, it being possible for phenyl and benzyl in turn to be mono- or poly-substituted by halogen, C₁-C₄alkyl, C₁-C₄haloalkyl, C₁-C₄alkoxy, —CN, —NO₂, C₁-C₄alkylthio, C₁-C₄alkylsulfinyl or by C₁-C₄alkylsulfonyl; or
R₈ and R₉ together are C₂-C₅alkylene;
R₁₀ is hydrogen, C₁-C₄alkyl, C₁-C₄haloalkyl or C₃-C₆cycloalkyl;
R₁₁ is hydrogen, C₁-C₈alkyl, C₃-C₈alkenyl, C₃-C₈alkynyl, C₁-C₄haloalkyl or C₃-C₆haloalkenyl;
R₁₂ is hydrogen, C₁-C₄alkyl, C₁-C₄haloalkyl or C₃-C₆cycloalkyl;
R₁₃ is hydrogen, C₁-C₈alkyl, C₃-C₈alkenyl or C₃-C₈alkynyl; or
R₁₃ is phenyl or phenyl-C₁-C₆alkyl, it being possible for the phenyl ring in turn to be mono- or poly-substituted by halogen, C₁-C₄alkyl, C₁-C₄haloalkyl, C₁-C₄alkoxy, —CN, —NO₂ or by —S(O)₂C₁-C₈alkyl, or
R₁₃ is C₁-C₈alkyl mono- or poly-substituted by halogen, —CN or by C₁-C₄alkoxy;
R₁₄ is hydrogen, C₁-C₈alkyl, C₃-C₈alkenyl or C₃-C₈alkynyl, or is C₁-C₈alkyl mono- or poly-substituted by halogen, —CN or by C₁-C₄alkoxy;
R₁₅, R₁₆ and R₁₇ are each independently of the others C₁-C₈alkyl, C₃-C₈alkenyl or C₃-C₈-alkynyl, or C₁-C₈alkyl mono- or poly-substituted by halogen, —CN or by C₁-C₄alkoxy;
R₁₈ is hydrogen or C₁-C₈alkyl;
R₁₉ is hydrogen, C₁-C₈alkyl, C₃-C₈alkenyl, C₃-C₈alkynyl, phenyl or benzyl, it being possible for phenyl and benzyl in turn to be mono- or poly-substituted by halogen, C₁-C₄alkyl, C₁-C₄halo-alkyl, C₁-C₄alkoxy, —CN, —NO₂, C₁-C₄alkylthio, C₁-C₄alkylsulfinyl or by C₁-C₄alkylsulfonyl; or
R₁₈ and R₁₉ together are a C₂-C₅alkylene chain which may be interrupted by an oxygen or sulfur atom;
R₂₀ is hydrogen, C₁-C₈alkyl, C₃-C₈alkenyl, C₃-C₈alkynyl, phenyl or benzyl, it being possible for phenyl and benzyl in turn to be mono- or poly-substituted by halogen, C₁-C₄alkyl, C₁-C₄halo-alkyl, C₁-C₄alkoxy, —CN, —NO₂, C₁-C₄alkylthio, C₁-C₄alkylsulfinyl or by C₁-C₄alkylsulfonyl;
R₂₁ is hydrogen or C₁-C₈alkyl;
R₂₂ Is hydrogen or C₁-C₈alkyl, or is C₁-C₈alkyl mono- or poly-substituted by COOH, C₁-C₈-alkoxycarbonyl or by —CN, or
R₂₂ is C₃-C₈alkenyl, C₃-C₈alkynyl, phenyl or benzyl, it being possible for phenyl and benzyl in turn to be mono- or poly substituted by halogen, C₁-C₄alkyl, C₁-C₄-haloalkyl, C₁-C₄alkoxy, —CN, —NO₂, C₁-C₄alkylthio, C₁-C₄alkylsulfinyl or by C₁-C₄alkylsulfonyl; or
R₂₁ and R₂₂ together are C₂-C₅alkylene;
R₂₃ is hydrogen, C₁-C₄alkyl, C₁-C₄haloalkyl or C₃-C₆cycloalkyl;
R₂₄ is hydrogen, C₁-C₄alkyl, C₁-C₄haloalkyl or C₃-C₆cycloalkyl;
R₂₅ is hydrogen, C₁-C₈alkyl, C₃-C₈alkenyl, C₃-C₈alkynyl, C₁-C₄haloalkyl or C₃-C₆haloalkenyl;
R₂₆ is hydrogen or C₁-C₈alkyl;
R₂₇ is hydrogen or C₁-C₈alkyl, or is C₁-C₈alkyl mono- or poly-substituted by COOH, C₁-C₈-alkoxycarbonyl or by —CN, or
R₂₇ is C₃-C₈alkenyl, C₃-C₈alkynyl, phenyl or benzyl, it being possible for phenyl and benzyl in turn to be mono- or poly-substituted by halogen, C₁-C₄alkyl, C₁-C₄haloalkyl, C₁-C₄alkoxy, —CN, —NO₂, C₁-C₄alkylthio, C₁-C₄alkylsulfinyl or by C₁-C₄alkylsulfonyl; or
R₂₆ and R₂₇ together are C₂-C₅alkylene;
R₂₈ is hydrogen or C₁-C₈alkyl;
R₂₉ and R₃₀ are each independently of the other hydrogen, C₁-C₈alkyl, C₃-C₈alkenyl or C₃-C₈alkynyl, or C₁-C₈alkyl mono- or poly-substituted by halogen, —CN or by C₁-C₄alkoxy;
R₃₁ and R₃₂ are each independently of the other C₁-C₈alkyl, C₃-C₈alkenyl or C₃-C₈alkynyl, or C₁-C₈alkyl mono- or poly-substituted by halogen, —CN or by C₁-C₄alkoxy;
m is 0, 1, 2, 3, 4 or 5;
each R₂ independently is halogen, —CN, —SCN, —SF₅, —NO₂, —NR₃₆R₃₇, —CO₂R₃₈, —CONR₃₉R₄₀, —C(R₄₁)═NOR₄₂, —COR₄₃, —OR₄₄, —SR₄₅, —SOR₄₆, —SO₂R₄₇, OSO₂R₄₈—N([CO]ₚR₄₉)COR₅₀, —N(OR₅₁)COR₅₂, —N(R₅₃)CO₂R₅₄ or —N-phthalimide;
R₃₆ is hydrogen or C₁-C₈alkyl; and
R₃₇ is hydrogen, C₁-C₈alkyl, C₃-C₈alkenyl, C₃-C₈alkynyl, phenyl or benzyl, it being possible for phenyl and benzyl in turn to be mono- or poly-substituted by halogen, C₁-C₄alkyl, C₁-C₄halo-alkyl, C₁-C₄alkoxy, —CN, —NO₂, C₁-C₄alkylthio, C₁-C₄alkylsulfinyl or by C₁-C₄alkylsulfonyl; or
R₃₆ and R₃₇ together are a C₂-C₅alkylene chain which may be interrupted by an oxygen or sulfur atom;
R₃₈ is hydrogen, C₁-C₈alkyl, C₃-C₈alkenyl or C₃-C₈alkynyl, or is C₁-C₈alkyl, C₃-C₈alkenyl or C₃-C₈alkynyl mono- or poly-substituted by halogen, C₁-C₄alkoxy or by phenyl, it being possible for phenyl in turn to be mono- or poly-substituted by halogen, C₁-C₄alkyl, C₁-C₄halo-alkyl, C₁-C₄alkoxy, —CN, —NO₂, C₁-C₄alkylthio, C₁-C₄alkylsulfinyl or by C₁-C₄alkylsulfonyl;
R₃₉ is hydrogen or C₁-C₈alkyl;
R₄₀ is hydrogen or C₁-C₈alkyl, or is C₁-C₈alkyl mono- or poly-substituted by —COOH, C₁-C₈-alkoxycarbonyl or by —CN, or
R₄₀ is C₃-C₈alkenyl, C₃-C₈alkynyl, phenyl or benzyl, it being possible for phenyl and benzyl in turn to be mono- or poly-substituted by halogen, C₁-C₄alkyl, C₁-C₄haloalkyl, C₁-C₄alkoxy, —CN, —NO₂, C₁-C₄alkylthio, C₁-C₄alkylsulfinyl or by C₁-C₄alkylsulfonyl; or
R₃₉ and R₄₀ together are C₃-C₅alkylene;
R₄₁ is hydrogen, C₁-C₄alkyl, C₁-C₄haloalkyl or C₃-C₆cycloalkyl;
R₄₂ is hydrogen, C₁-C₈alkyl, C₃-C₈alkenyl, C₃-C₈alkynyl, C₁-C₄haloalkyl or C₃-C₆haloalkenyl;
R₄₃ is hydrogen, C₁-C₄alkyl, C₁-C₄haloalkyl or C₃-C₆cycloalkyl;
R₄₄ is hydrogen, C₁-C₈alkyl, C₃-C₈alkenyl or C₃-C₈alkynyl; or
R₄₄ is phenyl or phenyl-C₁-C₆alkyl, it being possible for the phenyl ring in turn to be mono- or poly-substituted by halogen, C₁-C₄alkyl, C₁-C₄haloalkyl, C₁-C₄alkoxy, —CN, —NO₂ or by —S(O)₂C₁-C₈alkyl, or
R₄₄ is C₁-C₈alkyl mono- or poly-substituted by halogen, —CN or by C₁-C₄alkoxy;
R₄₅ is hydrogen, C₁-C₈alkyl, C₃-C₈alkenyl or C₃-C₈alkynyl, or is C₁-C₈alkyl mono- or poly-substituted by halogen, —CN or by C₁-C₄alkoxy;
R₄₆, R₄₇ and R₄₈ are each independently of the others C₁-C₈alkyl, C₃-C₈alkenyl or C₃-C₈-alkynyl, or C₁-C₈alkyl mono- or poly-substituted by halogen, —CN or by C₁-C₄alkoxy;
p is 0 or 1;
R₄₉, R₅₀, R₅₁, R₅₂, R₅₃ and R₅₄ are each independently of the others hydrogen, C₁-C₈alkyl, or phenyl which may in turn be mono- or poly-substituted by halogen, C₁-C₈alkyl, C₁-C₄halo-alkyl, C₁-C₄alkoxy, —CN, —NO₂, C₁-C₈alkylthio, C₁-C₈alkylsulfinyl or by C₁-C₈alkylsulfonyl; or
each R₂ independently is C₁-C₈alkyl, or is C₁-C₈alkyl mono- or poly-substituted by halogen, —CN, —NO₂, —NR₅₅R₅₆, —CO₂R₅₇, —CONR₅₈R₅₉, —COR₆₀, —C(R₆₁)═NOR₆₂, —C(S)NR₆₃R₆₄, —C(C₁-C₄alkylthio)=NR₆₅, —OR₆₆, —SR₆₇, —SOR₆₈, —SO₂R₆₉, —O(SO₂)R₇₀, —N(R₇₁)CO₂R₇₂, —N(R₇₃)COR₇₄ or by C₃-C₆cycloalkyl; or
each R₂ independently is C₂-C₈alkenyl, or is C₂-C₈alkenyl mono- or poly-substituted by —CN, —NO₂, —CO₂R₇₅, —CONR₇₆R₇₇, —COR₇₈, —C(R₇₉)═NOR₈₀, —C(S)NR₈₁R₈₂, —C(C₁-C₄alkylthio)=NR₈₃ or by C₃-C₆cycloalkyl; or
each R₂ in dependently is C₂-C₈alkynyl, or is C₂-C₈alkynyl mono- or poly-substituted by halogen, —CN, —CO₂R₈₄, —CONR₈₅R₈₆, —COR₈₇, —C(R₈₈)═NOR₈₉, —C(S)NR₉₀R₉₁,
—C(C₁-C₄alkylthio)=NR₉₂ or by C₃-C₆cycloalkyl; or
each R₂ independently is C₃-C₆cycloalkyl, or is C₃-C₆cycloalkyl mono- or poly-substituted by halogen, —CN, —CO₂R₉₃, —CONR₉₄R₉₅, —COR₉₆, —C(R₉₇)═NOR₉₈, —C(S)NR₉₉R₁₀₀ or by —C(C₁-C₄alkylthio)=NR₁₀₁; or
two adjacent R₂ substituents together form a C₁-C₇alkylene bridge which may be interrupted by 1 or 2 non-adjacent oxygen atoms and substituted by C₁-C₆alkyl, the total number of ring atoms being at least 5 and at most 9; or two adjacent R₂ substituents together form a C₂-C₇alkenylene bridge which may be interrupted by 1 or 2 non-adjacent oxygen atoms and substituted by C₁-C₆alkyl, the total number of ring atoms being at least 5 and at most 9;
R₅₅ is hydrogen or C₁-C₈alkyl;
R₅₆ is hydrogen, C₁-C₈alkyl, C₃-C₈alkenyl, C₃-C₈alkynyl, phenyl or benzyl, it being possible for phenyl and benzyl in turn to be mono- or poly-substituted by halogen, C₁-C₄alkyl, C₁-C₄halo-alkyl, C₁-C₄alkoxy, —CN, —NO₂, C₁-C₄alkylthio, C₁-C₄alkylsulfinyl or by C₁-C₄alkylsulfonyl; or
R₅₅ and R₅₆ together are a C₂-C₅alkylene chain which may be interrupted by an oxygen or sulfur atom;
R₅₇ is hydrogen, C₁-C₈alkyl, C₃-C₈alkenyl or C₃-C₈alkynyl, or is C₁-C₈alkyl, C₃-C₈alkenyl or C₃-C₈alkynyl mono- or poly-substituted by halogen, C₁-C₄alkoxy or by phenyl, it being possible for phenyl in turn to be mono- or poly-substituted by halogen, C₁-C₄alkyl, C₁-C₄halo-alkyl, C₁-C₄alkoxy, —CN, —NO₂, C₁-C₄alkylthio, C₁-C₄alkylsulfinyl or by C₁-C₄alkylsulfonyl;
R₅₈ is hydrogen or C₁-C₈alkyl;
R₅₉ is hydrogen or C₁-C₈alkyl, or is C₁-C₈alkyl mono- or poly-substituted by —COOH, C₁-C₈-alkoxycarbonyl or by —CN; or
R₅₉ is C₃-C₈alkenyl, C₃-C₈alkynyl, phenyl or benzyl, it being possible for phenyl and benzyl in turn to be mono- or poly-substituted by halogen, C₁-C₄alkyl, C₁-C₄haloalkyl, C₁-C₄alkoxy, —CN, —NO₂, C₁-C₄alkylthio, C₁-C₄alkylsulfinyl or by C₁-C₄alkylsulfonyl; or
R₅₈ and R₅₉ together are C₂-C₅alkylene;
R₆₀ is hydrogen, C₁-C₄alkyl, C₁-C₄haloalkyl or C₃-C₆cycloalkyl;
R₆₁ is hydrogen, C₁-C₄alkyl, C₁-C₄haloalkyl or C₃-C₆cycloalkyl;
R₆₂ is hydrogen, C₁-C₈alkyl, C₃-C₈alkenyl, C₃-C₈alkynyl, C₁-C₄haloalkyl or C₃-C₆haloalkenyl; and
R₆₃ is hydrogen or C₁-C₈alkyl;
R₆₄ is hydrogen or C₁-C₈alkyl, or is C₁-C₈alkyl mono- or poly-substituted by —COOH, C₁-C₈-alkoxycarbonyl or by —CN; or
R₆₄ is C₃-C₈alkenyl, C₃-C₈alkynyl, phenyl or benzyl, it being possible for phenyl and benzyl in turn to be mono- or poly-substitute by halogen, C₁-C₄alkyl, C₁-C₄-haloalkyl, C₁-C₄alkoxy, —CN, —NO₂, C₁-C₄alkylthio, C₁-C₄alkylsulfinyl or by C₁-C₄alkylsulfonyl; or
R₆₃ and R₆₄ together are C₂-C₅alkylene;
R₆₅ is hydrogen or C₁-C₈alkyl;
R₆₆ and R₆₇ are each independently of the other hydrogen, C₁-C₈alkyl, C₃-C₈alkenyl, C₃-C₈alkynyl, or C₁-C₈alkyl mono- or poly-substituted by halogen, —CN or by C₁-C₄alkoxy;
R₆₈ R₆₉ and R₇₀ are each independently of the other C₁-C₈alkyl, C₃-C₈alkenyl or C₃-C₈alkynyl, or C₁-C₈alkyl mono- or poly-substituted by halogen, —CN or by C₁-C₄alkoxy;
R₇₁ and R₇₃ are each independently of the other hydrogen, C₁-C₈alkyl or C₁-C₈alkoxy;
R₇₂ is C₁-C₈alkyl;
R₇₄ is hydrogen or C₁-C₈alkyl;
R₇₅ is hydrogen, or is C₁-C₈alkyl, C₃-C₈alkenyl or C₃-C₈alkynyl, each of which may be mono- or poly-substituted by halogen, C₁-C₄alkoxy or by phenyl, it being possible for phenyl in turn to be mono- or poly-substituted by halogen, C₁-C₄alkyl, C₁-C₄haloalkyl, C₁-C₄alkoxy, —CN, —NO₂, C₁-C₄alkylthio, C₁-C₄alkylsulfinyl or by C₁-C₄alkylsulfonyl;
R₇₆ is hydrogen or C₁-C₈alkyl;
R₇₇ is hydrogen or C₁-C₈alkyl, or is C₁-C₈alkyl mono- or poly-substituted by —COOH, C₁-C₈-alkoxycarbonyl or by —CN; or
R₇₇ is C₃-C₈alkenyl, C₃-C₈alkynyl, phenyl or benzyl, it being possible for phenyl and benzyl in turn to be mono- or poly-substituted by halogen, C₁-C₄alkyl, C₁-C₄haloalkyl, C₁-C₄alkoxy, —CN, —NO₂, C₁-C₄alkylthio, C₁-C₄alkylsulfinyl or by C₁-C₄alkylsulfonyl; or
R₇₆ and R₇₇ together are C₂-C₅alkylene;
R₇₈ and R₇₉ are each independently of the other hydrogen, C₁-C₄alkyl, C₁-C₄haloalkyl or C₃-C₆cycloalkyl;
R₈₀ is hydrogen, C₁-C₈alkyl, C₃-C₈alkenyl, C₃-C₈alkynyl, C₁-C₄haloalkyl or C₃-C₆haloalkenyl;
R₈₁ is hydrogen or C₁-C₈alkyl;
R₈₂ is hydrogen or C₁-C₈alkyl, or is C₁-C₈alkyl mono- or poly-substituted by —COOH, C₁-C₈-alkoxycarbonyl or by —CN; or
R₈₂ is C₃-C₈alkenyl, C₃-C₈alkynyl, phenyl or benzyl, it being possible for phenyl and benzyl in turn to be mono- or poly-substituted by halogen, C₁-C₄alkyl, C₁-C₄haloalkyl, C₁-C₄alkoxy, —CN, —NO₂, C₁-C₄alkylthio, C₁-C₄alkylsulfinyl or by C₁-C₄alkylsulfonyl; or
R₈₁ and R₈₂ together are C₂-C₅alkylene;
R₈₃ is hydrogen or C₁-C₈alkyl;
T₈₄ hydrogen, or is C₁-C₈alkyl, C₃-C₈alkenyl or C₃-C₈alkynyl, each of which may be mono- or poly-substituted by halogen, C₁-C₄alkoxy or by phenyl it being possible for phenyl in turn to be mono- or poly-substituted by halogen, C₁-C₄alkyl, C₁-C₄haloalkyl, C₁-C₄alkoxy, —CN, —NO₂, C₁-C₄alkylthio, C₁-C₄alkylsulfinyl or by C₁-C₄alkylsulfonyl;
R₈₅ is hydrogen or C₁-C₈alkyl;
R₈₆ is hydrogen or C₁-C₈alkyl, or is C₁-C₈alkyl mono- or poly-substituted by —COOH, C₁-C₈-alkoxycarbonyl or by —CN; or
R₈₆ is C₃-C₈alkenyl, C₃-C₈alkynyl, phenyl or benzyl, it being possible for phenyl and benzyl in turn to be mono- or poly-substituted by halogen, C₁-C₄alkyl, C₁-C₄haloalkyl, C₁-C₄alkoxy, —CN, —NO₂, C₁-C₄alkylthio, C₁-C₄alkylsulfinyl or by C₁-C₄alkylsulfonyl; or
R₈₅ and R₈₆ together are C₂-C₅alkylene;
R₈₇ is hydrogen, C₁-C₄alkyl, C₁-C₄haloalkyl or C₃-C₆cycloalkyl;
R₈₈ is hydrogen, C₁-C₄alkyl, C₁-C₄haloalkyl or C₃-C₆cycloalkyl;
R₈₉ is hydrogen, C₁-C₈alkyl, C₃-C₈alkenyl, C₃-C₈alkynyl, C₁-C₄haloalkyl or C₃-C₆haloalkenyl;
R₉₀ is hydrogen or C₁-C₈alkyl;
R₉₁ is hydrogen or C₁-C₈alkyl, or is C₁-C₈alkyl mono- or poly-substituted by —COOH, C₁-C₈-alkoxycarbonyl or by —CN; or
R₉₁ is C₃-C₈alkenyl, C₃-C₈alkynyl, phenyl or benzyl, it being possible for phenyl and benzyl in turn to be mono- or poly-substituted by halogen, C₁-C₄alkyl, C₁-C₄haloalkyl, C₁-C₄alkoxy, —CN, —NO₂, C₁-C₄alkylthio, C₁-C₄alkylsulfinyl or by C₁-C₄alkylsulfonyl; or
R₉₀ and R₉₁ together are C₂-C₅alkylene;
R₉₂ is hydrogen or C₁-C₈alkyl;
R₉₃ is hydrogen, or is C₁-C₈alkyl, C₃-C₈alkenyl or C₃-C₈alkynyl, each of which may be mono- or poly-substituted by halogen, C₁-C₄alkoxy or by phenyl, it being possible for phenyl in turn to be mono- or poly-substituted by halogen, C₁-C₄alkyl, C₁-C₄haloalkyl, C₁-C₄alkoxy, —CN, —NO₂, C₁-C₄alkylthio, C₁-C₄alkylsulfinyl or by C₁-C₄alkylsulfonyl;
R₉₄ is hydrogen or C₁-C₈alkyl;
R₉₅ is hydrogen or C₁-C₈alkyl, or is C₁-C₈alkyl mono- or poly-substituted by —COOH, C₁-C₈-alkoxycarbonyl or by —CN; or
R₉₅ is C₃-C₈alkenyl, C₃-C₈alkynyl, phenyl or benzyl, it being possible for phenyl and benzyl in turn to be mono- or poly-substituted by halogen, C₁-C₄alkyl, C₁-C₄haloalkyl, C₁-C₄alkoxy, —CN, —NO₂, C₁-C₄alkylthio, C₁-C₄alkylsulfinyl or by C₁-C₄alkylsulfonyl; or
R₉₄ and R₉₅ together are C₂-C₅alkylene;
R₉₆ is hydrogen, C₁-C₄alkyl, C₁-C₄haloalkyl or C₃-C₆cycloalkyl;
R₉₇ is hydrogen, C₁-C₄alkyl, C₁-C₄haloalkyl or C₃-C₆cycloalkyl;
R₉₈ is hydrogen, C₁-C₈alkyl, C₃-C₈alkenyl, C₃-C₈alkynyl, C₁-C₄haloalkyl or C₃-C₆haloalkenyl;
R₉₉ is hydrogen or C₁-C₈alkyl;
R₁₀₀ is hydrogen or C₁-C₈alkyl, or is C₁-C₈alkyl mono- or poly-substituted by —COOH, C₁-C₈-alkoxycarbonyl or by —CN; or
R₁₀₀ is C₃-C₈alkenyl, C₃-C₈alkynyl, phenyl or benzyl, it being possible for phenyl and benzyl in turn to be mono- or poly-substituted by halogen, C₁-C₄alkyl, C₁-C₄haloalkyl, C₁-C₄alkoxy, —CN, —NO₂, C₁-C₄alkylthio, C₁-C₄alkylsulfinyl or by C₁-C₄alkylsulfonyl; or
R₉₉ and R₁₀₀ together are C₂-C₅alkylene; and
R₁₀₁ is hydrogen or C₁-C₈alkyl,
or an agrochemically acceptable salt or any stereoisomer or tautomer of a compound of formula I, and
b) a synergistically effective amount of one or more compounds selected from the group consisting of the co-herbicides:
triasulfuron (773), prosulfuron (657), clodinafop-propargyl (156), terbutryn (740), dicamba (222), fenoxaprop-P-ethyl (331), metamifop, diclofop-methyl (232), tralkoxydim (767), butroxydim (104), amidosulfuron (24), chlorsulfuron (146), ethoxysulfuron (307), flupyrsulfuron (374), flupyrsulfuron-methyl-sodium (374), metsulfuron-methyl (536), sulfosulfuron (714), thifensulfuron-methyl (754), tribenuron-methyl (778), imazamethabenz-methyl (438), flucarbazone-sodium (357), iodosulfuron-methyl-sodium (454), florasulam (351), flumetsulam (366), metosulam (533), chlorotoluron (142), isoproturon (464), methabenzthiazuron (510), bromoxynil (93), ioxynil (455), pyridate (672), bifenox (75), fluoroglycofen-ethyl (371), carfentrazone-ethyl (119), fluazolate (355), diflufenican (245), flurtamone (382), glyphosate (407), sulfosate (407), glufosinate (406), S-glufosinate, bialaphos (bilanafos; (77)), ethalfluralin (298), pendimethalin (599), 2,4-DB (211), dichlorprop (2,4-DP; (228)), MCPA (485), MCPB (487), mecoprop (MCPP; (489)), mecoprop-P (490), clopyralid (162), fluroxypyr (380), quinmerac (682), benazolin-ethyl (59), difenzoquat metilsulfate (242), cyhalofop-butyl (191), trifluralin (791), fluthiamide (flufenacet; (362)), isoxaben (466), prosulfocarb (656), triallate (772), 2,4-D (205); benfluamid, cinidon-ethyl (152), flufenpyr, picolinafen (Code No. AC 900001; (621)), propoxycarbazone (Code No. MKH 6561; (541)); pretilachlor (632), cinosulfuron (154), fenclorim (325), pyriftalid (Code No. CGA 279 233), metolachlor (529), S-metolachlor (530), mixtures of metolachlor and S-metolachlor, preferably mixtures thereof containing 50-90% especially 70-90% S-metalachlor, bensulfron-methyl (66), imazosulfuron (444), pyrazosulfuron-ethyl (665) azimsulfuron (45), esprocarb (296) mefenacet (491), molinate (542), propanil (644), pyrazolate (pyrazolynate; (663)), fenoxaprop-ethyl (“The Pesticide Manual”, Editor C. Tomlin, 10th Edition, British Crop Protection Council, 1994, Entry No. (299)), bispyribac (82), bispyribac-sodium (82), pyriminobac-methyl (676), cafenstrole (108), oxaziclomefone (Code No. MY-100; (583)), dymron (daimuron; (207)), fentrazamide (Code No. NBA 061; (340)), indanofan (Code No. MK243; (450)), etobenzanid (Code No. HW-52; (311)), oxadiargyl (578), halosulfuron-methyl (414), clomazone (159), oxadiazon (579), benzobicyclon (Code No. SAN1315H; (70)), mefenpyr-diethyl (492);
profoxydim (Code No. BAS 625H; (54)), pyrazogyl;
cyclosulfamuron (186), flazasulfuron (349), flufenacet (362), benfuresate (63), bentazone (69), bromobutide (91), dithiopyr (275), ethametsulfuron-methyl (299), flamprop-M (348), methyldymron (521), quinclorac (681), thiazopyr (752) and mesosulfuron.

The above herbicidal active ingredients under b) are known and are described, for example, in “The Pesticide Manual”, Editor C. D. S. Tomlin, 12th Edition, British Crop Protection Council, 2000 under the Entry Nos. included in brackets; for example, triasulfuron (773) is described therein under Entry No. 773.

The S-enantiomer of glufosinate (406), S-glufosinate, is registered under CAS Reg. No. [35597-44-5].

Metamifop (Dongbu Hannong; Code No. DBH 129) is known as a herbicide and is registered under CAS Reg. No. [256412-89-2].

Fluazolate (Monsanto; Code No. JV-485, MON 48500) is also known as a herbicide under the common name isopropazole and is registered under CAS Reg. No. [174514-07-9].

The compound of formula 2.1 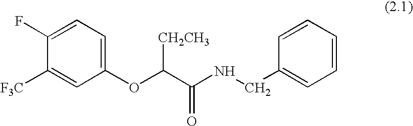
is known as a herbicide under the common name, benfluamid (UBE; Code no. UBH 820) and is registered under CAS Reg. No. [113604-08-7].

Flufenpyr is known as a herbicide and is registered under CAS Reg. No. [188489-06-7].

The compound of formula 2.2 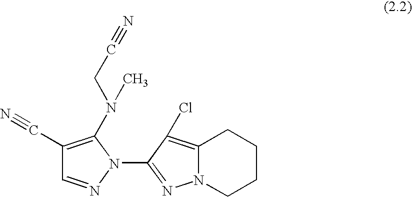
is known as a herbicide under the common name pyrazogyl (Aventis; Code No. AEB 172391) and is registered under CAS Reg. No. [158353-15-2].

The compound of formula 2.3 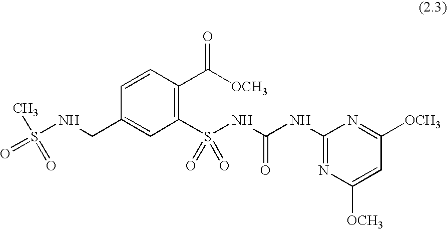
is known as a herbicide under the common name mesosulfuron (Aventis; Code No. AEF 130060) and is registered under CAS Reg. No. [208465-21-8].

Pyriftalid and its preparation are described, for example, in EP-B-0 447506.

The invention also includes the salts that the compounds of formula I having acid hydrogen, especially the derivatives having carboxylic acid groups (e.g. carboxyl-substituted alkyl, alkenyl an alkynyl groups), are able to form with amines, alkali metal and alkaline earth metal bases or quaternary ammonium bases. Among the alkali metal and alkaline earth metal hydroxides used as salt formers, emphasis is to be given to the hydroxides of lithium, sodium, potassium, magnesium and calcium, but especially to those of sodium and potassium.

Examples of suitable amines for ammonium salt formation that come into consideration are ammonia as well as primary, secondary and tertiary C₁-C₁₈alkylamines, C₁-C₄hydroxyalkyl-amines and C₂-C₄alkoxyalkylamines, for example methylamine, ethylamine, n-propylamine, isopropylamine, the four butylamine isomers, n-amylamine, isoamylamine, hexylamine, heptylamine, octylamine, nonylamine, decylamine, pentadecylamine, hexadecylamine, heptadecylamine, octadecylamine, methyl-ethylamine, methyl-isopropylamine, methyl-hexylamine, methyl-nonylamine, methyl-pentadecylamine, methyl-octadecylamine, ethyl-butylamine, ethyl-heptylamine, ethyl-octylamine, hexyl-heptylamine, hexyl-octylamine, dimethylamine, diethylamine, di-n-propylamine, diisopropylamine, di-n-butylamine, di-n-amylamine, diisoamylamine, dihexylamine, diheptylamine, dioctylamine, ethanolamine, n-propanolamine, isopropanolamine, N,N-diethanolamine, N-ethylpropanolamine, N-butyl-ethanolamine, allylamine, n-butenyl-2-amine, n-pentenyl-2-amine, 2,3dimethylbutenyl-2-amine, dibutenyl-2-amine, n-hexenyl-2-amine, propylenediamine, trimethylamine, triethyl-amine, tri-n-propylamine, triisopropylamine, tri-n-butylamine, triisobutylamine, tri-sec-butyl-amine, tri-n-amylamine, methoxyethylamine and ethoxyethylamine; heterocyclic amines, for example pyridine, quinoline, isoquinoline, morpholine, piperidine, pyrrolidine, indoline, quinuclidine and azepine; primary arylamines, for example anilines, methoxyanilines, ethoxy-anilines, o-, m- and p-toluidines, phenylenediamines, benzidines, naphthylamines and o-, m- and p-chloroanilines; but especially triethylamine, isopropylamine and diisopropylamine.

Preferred compounds of formula I are those wherein each RI independently is halogen, —CN, —NO₂, —C(R₁₀)═NOR₁₁, —OR₁₃, —SO₂R₁₆, —OSO₂R₁₇, C₁-C₈alkyl or C₂-C₈alkenyl, or is C₁-C₈alkyl mono- or poly-substituted by halogen or by —CN;
R₁₀ is hydrogen or C₁-C₄alkyl; and
R₁₁ is C₁-C₈alkyl.

Preference is given also to those compounds of formula I wherein
each R₂ independently is halogen, —CN, —NO₂, —NR₃₆R₃₇, —CO₂R₃₈, —C(R₄₁)═NOR₄₂, —OR₄₄, —SO₂R₄₇, —OSO₂R₄₈ or C₁-C₈alkyl, or is C₁-C₈alkyl mono- or poly-substituted by halogen, —CN or by —CO₂R₅₇;
R₃₆ and R₃₇ are hydrogen;
R₃₈ is hydrogen or C₁-C₈alkyl;
R₄₁ is hydrogen or C₁-C₄alkyl; and
R₄₂ is C₁-C₈alkyl.

An especially preferred group of compounds of formula I comprises those compounds wherein each R₁ independently is halogen, —CN, —NO₂, —C(R₁₀)═NOR₁₁, —OR₁₃, —SO₂R₁₆, —OSO₂R₁₇, C₁-C₈alkyl or C₂-C₈alkenyl, or is C₁-C₈alkyl mono- or poly-substituted by —CN;
R₁₀ is hydrogen or C₁-C₄alkyl;
R₁₁ is C₁-C₈alkyl;
each R₂ independently is halogen, —CN, —NO₂, —NR₃₆R₃₇, —CO₂R₃₈, —C(R₄₁)═NOR₄₂, —OR₄₄, —SO₂R₄₇, —OSO₂R₄₈ or C₁-C₈alkyl, or is C₁-C₈alkyl mono- or poly-substituted by —CN or by —CO₂R₅₇;
R₃₆ and R₃₇ are hydrogen;
R₃₆ is hydrogen or C₁-C₈alkyl;
R₄₁ is hydrogen or C₁-C₄alkyl;
R₄₂ is C₁-C₈alkyl; and
R₃ and R₄ are each independently of the other hydrogen or C₁-C₄alkyl.

Also of interest are compounds of formula I wherein R₁ is halogen or —CN, or is C₁-C₈alkyl substituted by —CN, or is C₁-C₈alkoxy.

Very special preference is given to those compounds of formula I wherein R₂ is halogen, —CN, C₁-C₈alkyl substituted by —CN, or is C₁-C₈alkoxy, especially wherein at least one of the substituents R₁ or R₂ is C₁-C₈alkyl substituted by —CN.

Preference is given also to compounds of formula I wherein n is 0, 1 or 2 and m is 0, 1, 2, 3 or 4, especially wherein n is 1 or 2 and m is 1 or 2.

Of special interest are compounds of formula I wherein R₃ and R₄ are hydrogen.

In an outstanding group of compounds of formula I, the group 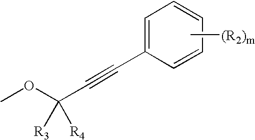
occupies the 2-position on the pyridine ring, preferably with n being 1 or 2 and R₁ occupying the 3- and/or 5-position on the pyridine ring.

Preference is given also to compounds of formula I wherein
m is 1 or 2 and R₂ occupies the 3-position on the phenyl ring.

Emphasis should be given also to compounds of formula I wherein R₁ is hydrogen, fluorine, chlorine, bromine, methoxy, difluoromethoxy, trifluoromethyl or isopropylthio;
R₂ is cyanomethyl, chlorine or bromine;
R₃ and R₄ are hydrogen;
n is 1 or 2 and
m is 1.

Preferred synergistic mixtures according to the invention for controlling weeds and grasses in crops of cereals comprise, as co-herbicides under b), compounds selected from the group: triasulfuron, prosulfuron, clodinafop-propargyl, terbutryn, fenoxaprop-P-ethyl, diclofop-methyl, tralkoxydim, butroxydim, amidosulfuron, chlorsulfuron, ethoxysulfuron, flupyrsulfuron-methyl-sodium, metsulfuron-methyl, sulfosulfuron, thifensulfuron-methyl, tribenuron-methyl, imazamethabenz-methyl, flucarbazone-sodium, iodosulfuron-methyl-sodium, florasulam, flumetsulam, metosulam, chlortoluron, methabenzthiazuron, bromoxynil, pyridate, bifenox, fluoroglycofen-ethyl, carfentrazone-ethyl, fluazolate, cyhalofop-butyl, azimsulfuron, bensulfuron-methyl, cinosulfuron, cyclosulfamuron, fentrazamide, flazasulfuron, fluazolate, bentazone, ethametsulfuron-methyl, halosulfuron-methyl, quinclorac, imazosulfuron, pyrazosulfuron-ethyl, benfluamid, cinidon-ethyl, flufenpyr, picolinafen and propoxycarbazone.

Preferred synergistic mixtures according to the invention for controlling weeds and grasses in crops of rice comprise, as co-herbicides under b), compounds selected from the group: pretilachlor, cinosulfuron, triasulfuron, fenclorim, pyriftalid, clodinafop-propargyl, metolachlor, S-metolachlor, mixtures of metolachlor and S-metolachlor, preferably mixtures thereof containing 50-90%, especially 70-90% S-metolachlor, bensulfuron-methyl, imazosulfuron, pyrazosulfuron-ethyl, metsulfuron-methyl, azimsulfuron, mefenacet, cyhalofop-butyl, fenoxaprop-ethyl fenoxaprop-P-ethyl, cafenstrole glyphosate, S-glufosinate, glufosinate, sulfosate, halosulfuron-methyl, oxadiazon, mefenpyr-diethyl, indanofan, profoxydim and pyrazogyl.

Further preferred synergistic mixtures according to the invention for controlling weeds and grasses in crops of cereals and rice comprise, as co-herbicides under b), compounds selected from the group: amidosulfuron, azimsulfuron, bensulfuron-methyl, bromoxynil, carfentrazone-ethyl, chlorsulfuron, cinosulfuron, clodinafop-propargyl, cyclosulfamuron, cyhalofop-butyl, dicamba, diclofop-methyl, ethoxysulfuron, fenoxaprop-P-ethyl, flazasulfuron, florasulam, fluazolate, flufenacet, flupyrsulfuron, flupyrsulfuron-methyl-sodium, sulfosulfuron, thifensulfuron, triasulfuron, tribenuron-methyl, benfuresate, bentazone, bromobutide, dithiopyr, ethametsulfuron-methyl, flamprop-M, fluoroglycofen-ethyl, halosulfuron-methyl, mefenacet, methyldymron, pyridate, quinclorac, quinmerac, thiazopyr, tralkoxydim, imazosulfuron, indanofan, MCPA, MCPB, pyrazosulfuron-ethyl and mesosulfuron.

It is extremely surprising that the combination of the compound of formula I with one or more active ingredients selected from the co-herbicides under b) exceeds the additive effect on the weeds to be controlled that is to be expected in principle and thus broadens the range of action of the individual active ingredients especially in two respects: firstly, the rates of application of the individual compounds of formula I and co-herbicides under b) are reduced while a good level of action is maintained and, secondly, the composition according to the invention achieves a high level of weed control also in those cases where the individual substances, in the low rates of application range, have become useless from the agronomic standpoint. The result is a considerable broadening of the spectrum of weeds and an additional increase in selectivity in respect of the crops of useful plants, as is necessary and desirable in the event of an unintentional overdose of active ingredient. The composition according to the invention, while retaining excellent control of weeds in crops of useful plants, also allows greater flexibility in succeeding crops.

The composition according to the invention can be used against a large number of agronomically important weeds, such as Stellaria, Nasturtium, Agrostis, Digitaria, Avena, Setaria, Sinapis, Lolium, Solanum, Phaseolus, Echinochloa, Scirpus, Monochoria, Sagittaria, Bromus, Alopecurus, Sorghum halepense, Rottboellia, Cyperus, Abutilon, Sida, Xanthium, Amaranthus, Chenopodium Ipomoea, Chrysanthemum, Galium, Viola and Veronica. The composition according to the invention is suitable for all methods of application conventionally used in agriculture, e.g. pre-emergence application, post-emergence application and seed dressing. The composition according to the invention is suitable especially for controlling weeds in crops of useful plants, such as rape, sugar beet, sugar cane, plantation crops, soybeans and, especially, cereals, rice and maize, and also for non-selective weed control.

“Crops” are to be understood to mean also those crops which have been made tolerant to herbicides or classes of herbicides as a result of conventional methods of breeding or genetic engineering.

The composition according to the invention comprises the compound of formula I and the co-herbicides under b) in any mixing ratio, but usually has an excess of one component over the others. Generally, the mixing ratios (ratios by weight) of the compound of formula I and the co-herbicides under b) are from 1:2000 to 2000:1, especially from 200:1 to 1:200.

The rate of application may vary within wide limits and depends on the nature of the soil, the method of application (pre- or post-emergence; seed dressing; application to the seed furrow; no tillage application etc.), the crop plant, the weed to be controlled, the prevailing climatic conditions, and other factors governed by the method of application, the time of application and the target crop. The active ingredient mixture according to the invention can generally be applied at a rate of from 1 to 5000 g of active ingredient mixture per ha.

The mixtures of the compound of formula I with the co-herbicides under b) may be used in unmodified form, that is to say as obtained in the synthesis. Preferably, however, they are formulated in customary manner, together with the adjuvants conventionally used in formulation technology, such as solvents, solid carriers or surfactants, for example into emulsifiable concentrates, directly sprayable or dilutable solutions, dilute emulsions, wettable powders, soluble powders, dusts, granules or microcapsules. As with the nature of the compositions, the methods of application, such as spraying, atomising, dusting, wetting, scattering or pouring, are chosen in accordance with the intended objectives and the prevailing circumstances.

The formulations, i.e. the compositions, preparations or mixtures comprising the compounds of formula I and the co-herbicides under b), and also, where appropriate, one or more solid or liquid formulation adjuvants, are prepared in a manner known per se, e.g. by intimately mixing and or grinding the active ingredients with the formulation adjuvants, e.g. solvents or solid carriers. In addition, surface-active compounds (surfactants) may also be used in the preparation of the formulations.

Examples of solvents and solid carriers are given, for example, in WO 97/34485. page 6.

Depending on the nature of the compound of formula I to be formulated, suitable surface-active compounds are non-ionic, cationic and/or anionic surfactants and surfactant mixtures having good emulsifying, dispersing and wetting properties.

Examples of suitable anionic, non-ionic and cationic surfactants are listed, for example, in WO 97/34485, pages 7 and 8.

Also suitable in the preparation of the herbicidal compositions according to the invention are the surfactants conventionally used in formulation technology, which are described, inter alia, in “McCutcheon's Detergents and Emulsifiers Annual” MC Publishing Corp., Ridgewood N.J., 1981, Stache, H., “Tensid-Taschenbuch”, Carl Hanser Verlag, Munich/Vienna, 1981 and M. and J. Ash, “Encyclopedia of Surfactants”, Vol I-III, Chemical Publishing Co., New York, 1980-81.

The herbicidal formulations usually contain from 0.1 to 99% by weight, especially from 0.1 to 95% by weight, of active ingredient mixture comprising a compound of formula I together with the co-herbicides under b), from 1 to 99.9% by weight of a solid or liquid formulation adjuvant, and from 0 to 25% by weight, especially from 0.1 to 25% by weight, of a surfactant.

Whereas commercial products preferably will usually be formulated as concentrates, the end user will normally employ dilute formulations. The compositions may also comprise further ingredients, such as stabilisers, e.g. vegetable oils or epoxidised vegetable oils (epoxidised coconut oil, rapeseed oil or soybean oil), antifoams, e.g. silicone oil, preservatives, viscosity regulators, binders, tackifiers, and also fertilisers or other active ingredients. Preferred formulations have especially the following compositions:
(%=percent by weight))

Emulsifiable Concentrates:

| | |
|---|---|
| active ingredient mixture: | 1 to 90%, preferably 5 to 20% |
| surfactant: | 1 to 30%, preferably 10 to 20% |
| liquid carrier: | 5 to 94%, preferably 70 to 85% |

Dusts:

| | |
|---|---|
| active ingredient mixture: | 0.1 to 10%, preferably 0.1 to 5% |
| solid carrier: | 99.9 to 90%, preferably 99.9 to 99% |

Suspension Concentrates:

| | |
|---|---|
| active ingredient mixture: | 5 to 75%, preferably 10 to 50% |
| water: | 94 to 24%, preferably 88 to 30% |
| surfactant: | 1 to 40%, preferably 2 to 30% |

Wettable Powders:

| | |
|---|---|
| active ingredient mixture: | 0.5 to 90%, preferably 1 to 80% |
| surfactant: | 0.5 to 20%, preferably 1 to 15% |
| solid carrier: | 5 to 95%, preferably 15 to 90% |

Granules:

| | |
|---|---|
| active ingredient mixture: | 0.1 to 30%, preferably 0.1 to 15% |
| solid carrier: | 99.5 to 70%, preferably 97 to 85% |

The following Examples illustrate the invention further, but do not limit the invention.

| F1. Emulsifiable concentrates | a) | b) | c) | d) |
|---|---|---|---|---|
| active ingredient mixture | 5% | 10% | 25% | 50% |
| calcium dodecylbenzenesulfonate | 6% | 8% | 6% | 8% |
| castor oil polyglycol ether | 4% | — | 4% | 4% |
| (36 mol of ethylene oxide) | | | | |
| octylphenol polyglycol ether | — | 4% | — | 2% |
| (7-8 mol of ethylene oxide) | | | | |
| cyclohexanone | — | — | 10% | 20% |
| arom. hydrocarbon mixture | 85% | 78% | 55% | 16% |
| C₉-C₁₂ | | | | |

Emulsions of any desired concentration can be obtained from such concentrates by dilution with water.

| F2. Solutions | a) | b) | c) | d) |
|---|---|---|---|---|
| active ingredient mixture | 5% | 10% | 50% | 90% |
| 1-methoxy-3-(3-methoxy- | — | 20% | 20% | — |
| propoxy)-propane | | | | |
| polyethylene glycol MW 400 | 20% | 10% | — | — |
| N-methyl-2-pyrrolidone | — | — | 30% | 10% |
| arom. hydrocarbon mixture | 75% | 60% | — | — |
| C₉-C₁₂ | | | | |

The solutions are suitable for use in the form of microdrops.

| F3. Wettable powders | a) | b) | c) | d) |
|---|---|---|---|---|
| active ingredient mixture | 5% | 25% | 50% | 80% |
| sodium lignosulfonate | 4% | — | 3% | — |
| sodium lauryl sulfate | 2% | 3% | — | 4% |
| sodium diisobutylnaphthalene- | — | 6% | 5% | 6% |
| sulfonate | | | | |
| octylphenol polyglycol ether | — | 1% | 2% | — |
| (7-8 mol of ethylene oxide) | | | | |
| highly dispersed silicic acid | 1% | 3% | 5% | 10% |
| kaolin | 88% | 62% | 35% | — |

The active ingredient is mixed thoroughly with the adjuvants and the mixture is thoroughly ground in a suitable mill, affording wettable powders which can be diluted with water to give suspensions of any desired concentration.

| F4. Coated granules | a) | b) | c) |
|---|---|---|---|
| active ingredient mixture | 0.1% | 5% | 15% |
| highly dispersed silicic acid | 0.9% | 2% | 2% |
| inorganic carrier | 99.0% | 93% | 83% |
| (diameter 0.1-1 mm) | | | |
| e.g. CaCO₃ or SiO₂ | | | |

The active ingredient is dissolved in methylene chloride and applied to the carrier by spraying, and the solvent is then evaporated off in vacuo.

| F5. Coated granules | a) | b) | c) |
|---|---|---|---|
| active ingredient mixture | 0.1% | 5% | 15% |
| polyethylene glycol MW 200 | 1.0% | 2% | 3% |
| highly dispersed silicic acid | 0.9% | 1% | 2% |
| inorganic carrier | 98.0% | 92% | 80% |
| (diameter 0.1-1 mm) | | | |
| e.g. CaCO₃ or SiO₂ | | | |

The finely ground active ingredient is uniformly applied, in a mixer, to the carrier moistened with polyethylene glycol. Non-dusty coated granules are obtained in this manner.

| F6. Extruder granules | a) | b) | c) | d) |
|---|---|---|---|---|
| active ingredient mixture | 0.1% | 3% | 5% | 15% |
| sodium lignosulfonate | 1.5% | 2% | 3% | 4% |
| carboxymethylcellulose | 1.4% | 2% | 2% | 2% |
| kaolin | 97.0% | 93% | 90% | 79% |

The active ingredient is mixed and ground with the adjuvants, and the mixture is moistened with water. The mixture is extruded and then dried in a stream of air.

| F7. Dusts | a) | b) | c) |
|---|---|---|---|
| active ingredient mixture | 0.1% | 1% | 5% |
| talcum | 39.9% | 49% | 35% |
| kaolin | 60.0% | 50% | 60% |

Ready-to-use dusts are obtained by mixing the active ingredient with the carriers and grinding the mixture in a suitable mill.

| F8. Suspension concentrates | a) | b) | c) | d) |
|---|---|---|---|---|
| active ingredient mixture | 3% | 10% | 25% | 50% |
| ethylene glycol | 5% | 5% | 5% | 5% |
| nonylphenol polyglycol ether | — | 1% | 2% | — |
| (15 mol of ethylene oxide) | | | | |
| sodium lignosulfonate | 3% | 3% | 4% | 5% |
| carboxymethylcellulose | 1% | 1% | 1% | 1% |
| 37% aqueous formaldehyde | 0.2% | 0.2% | 0.2% | 0.2% |
| solution | | | | |
| silicone oil emulsion | 0.8% | 0.8% | 0.8% | 0.8% |
| water | 87% | 79% | 62% | 38% |

The finely ground active ingredient is intimately mixed with the adjuvants, giving a suspension concentrate from which suspensions of any desired concentration can be obtained by dilution with water.

It is often more practical for the compound of formula I and the mixing partner or partners under b) to be formulated separately and then to be brought together in the desired mixing ratio in the applicator in the form of a “tank mixture” in water shortly before application.

### BIOLOGICAL EXAMPLES

A synergistic effect exists whenever the action of the active ingredient combination of the compound of formula I and co-herbicides under b) is greater than the sum of the actions of the active ingredients applied separately.

The herbicidal action to be expected We for a given combination of two herbicides can be calculated as follows (see COLBY, S. R., “Calculating synergistic and antagonistic response of herbicide combinations”, Weeds 15, pages 20-22, 1967):
We=X+[Y·(100−X)/100]
wherein:
X=percentage herbicidal action on treatment with the compound of formula I at a rate of application of p kg per hectare, compared with the untreated control (=0%).
Y=percentage herbicidal action on treatment with a co-herbicide under b) at a rate of application of q kg per hectare, compared with the untreated control.
We=expected herbicidal action (percentage herbicidal action compared with the untreated control) following treatment with the compound of formula I and co-herbicide under b) at a rate of application of p+q kg of active ingredient per hectare.

When the action actually observed is greater than the value to be expected We, there is a synergistic effect.

The synergistic effect of the combinations of the compound of formula I with the co-herbicides under b) is demonstrated in the following Examples.

Experiment Description—Pre-Emergence Test:

Monocotyledonous and dicotyledonous test plants are sown in standard soil in plastics pots. Directly after sowing, the test compounds are applied in aqueous suspension by spraying (500 litres of water per ha). The rates of application depend on the optimum concentrations determined under field conditions and greenhouse conditions. The test plants are then grown in the greenhouse under optimum conditions. The tests are evaluated after 36 days (% action, 100%=plant has died, 0%=no phytotoxic action).

The mixtures used in this test exhibit good results.

Experiment Description—Post-Emergence Test:

The test plants are grown to the 2- to 3-leaf stage in plastics pots under greenhouse conditions. A standard soil is used as cultivation substrate. At the 2- to 3-leaf stage, the herbicides are applied to the test plants both alone and in admixture. Application is carried out using an aqueous suspension of the test compounds in 500 litres of water per ha. The rates of application depend on the optimum concentrations determined under field conditions and greenhouse conditions. The tests are evaluated after 33 days (% action, 100%=plant has died, 0%=no phytotoxic action).

In this test, too, the mixtures used exhibit good results.

It has been shown, surprisingly, that specific safeners are suitable for mixing with the synergistic composition according to the invention. The present invention accordingly relates also to a selectively herbicidal composition for controlling grasses and weeds in crops of useful plants, especially in crops of cereals, rice and maize, that comprises a compound of formula I, one or more compounds selected from the co-herbicides under b), and a safener (counter agent, antidote) that protects the useful plants, but not the weeds, against the phytotoxic action of the herbicide, as well as to the use of such a composition in the control of weeds in crops of useful plants.

There is accordingly also proposed in accordance with the invention a selectively herbicidal composition that, in addition to comprising customary inert formulation adjuvants, such as carriers, solvents and wetting agents, comprises as active ingredient a mixture of
ab) an amount, effective for herbicide synergism, of a compound of formula I and one or more compounds selected from the co-herbicides under b) and
c) an amount, effective for herbicide antagonism, of a compound selected from the compound of formula 3.1

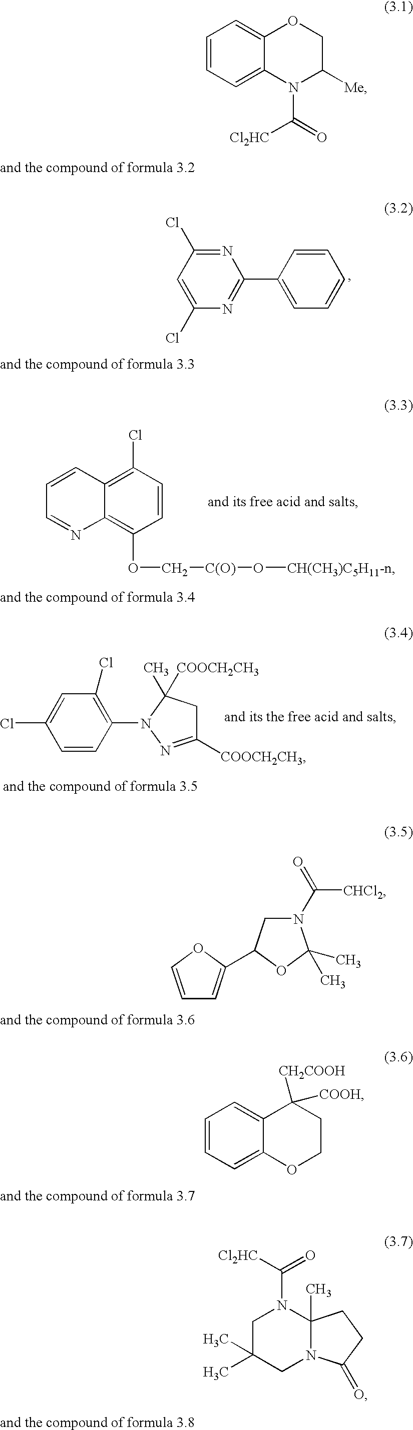

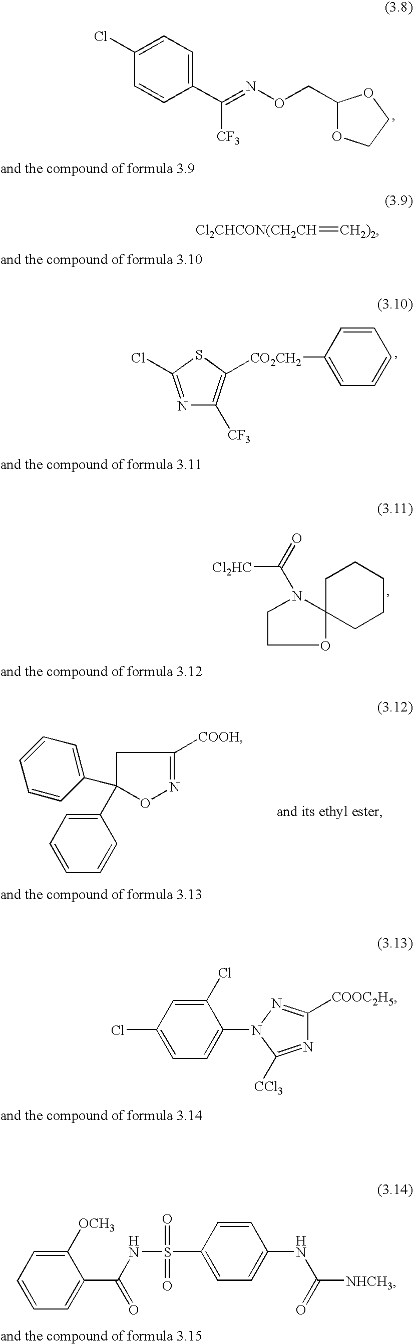

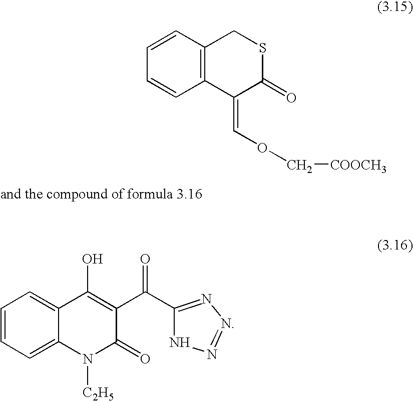

The compounds of formulae 3.1 to 3.16 are known and are described, for example, in the “Pesticide Manual”, 12th Edition, British Crop Protection Council, 2000 under the entry numbers 65 (formula 3.1, benoxacor), 325 (formula 3.2, fenclorim), 163 (formula 3.3, cloquintocet-mexyl), 492 (formula 3.4, mefenpyr-diethyl), 401 (formula 3.5, furilazole), 389 (formula 3.8, fluxofenim), 225 (formula 3.9, dichlormid) and 376 (formula 3.10 , flurazole). The compound of formula 3.11 is known under the designation MON 4660 (Monsanto) and is described, for example, in EP-A-0 436 483.

The free acid and salts of cloquintocet-mexyl (formula 3.3) are known, for example, from WO 02/34048, and the free acid and salts of mefenpyr-diethyl (formula 3.4) are known, for example, from WO 01/17353.

The compound of formula 3.6 (AC 304415) is described, for example, in EP-A-0 613 618, and the compound of formula 3.7 in DE-A-29 48 535. The compounds of formula 3.12 are known under the common names isoxadifen and isoxadifen-ethyl, are described in DE-A-43 31 448 and are registered under the CAS Reg. Nos. [209866-92-2] and [163520-33-0], and the compound of formula 3.13 is described in DE-A-35 25205. The compound of formula 3.14 is known, for example, from U.S. Pat. No. 5,215,570, and the compound of formula 3.15 from EP-A-0 929 543. The compound of formula 3.16 is described in WO 99/00020. In addition to the compound of formula 3.16, the other 3-(5-tetrazolyl-carbonyl)-2-quinolones described in WO 99/00020, especially the compounds specifically disclosed in Tables 1 and 2 on pages 21 to 29, are also suitable for protecting crop plants against the phytotoxic action of the compounds of formula I.

The invention relates also to a selectively herbicidal composition that, in addition to comprising customary inert formulation adjuvants, such as carriers, solvents and wetting agents, comprise as active ingredient a mixture of
a) a herbicidally effective amount of a compound of formula I and
c) an amount, effective for herbicide antagonism, of a compound selected from the compounds of formulae 3.1, 3.2, 3.3, 3.4, 3.5, 3.6, 3.7, 3.8, 3.9, 3.10, 3.11, 3.12, 3.13, 3.14, 3.15 and 3.16.

Preferred mixtures according to the invention comprise as safener a compound selected from the compounds of formulae 3.1, 3.3 and 3.8. Such safeners are suitable especially for those compositions according to the invention that comprise the above-mentioned preferred co-herbicides under b).

Combinations of the compound of formula I with the compound of formula 3.3 have been found to be very especially effective compositions. Such a composition is preferably used together with clodinafop-propargyl (156).

The invention relates also to a method for the selective control of weeds in crops of useful plants, which comprises treating the useful plants, seeds or cuttings thereof, or the area of cultivation thereof, with a herbicidally effective amount of a herbicide of formula I, optionally one or more herbicides selected from the co-herbicides under b), and an amount, effective for herbicide antagonism, of a safener from formulae 3.1 to 3.16.

As crop plants that can be protected by the safeners of formulae 3.1 to 3.16 against the damaging effect of the above-mentioned herbicides there come into consideration especially cotton, soybeans, sugar beet, sugar cane, plantation crops, rape and, very especially, cereals, rice and maize. “Crops” are to be understood to mean also those crops which have been made tolerant to herbicides or classes of herbicides as a result of conventional methods of breeding or genetic engineering.

The weeds to be controlled may be both monocotyledonous and dicotyledonous weeds, such as, for example Stellaria, Agrostis, Digitaria, Avena, Apera, Brachiaria, Phalaris, Setaria, Sinapis, Lolium, Solanum, Echinochloa, Scirpus, Monochoria, Sagittaria, Panicum, Bromus, Alopecurus, Sorghum halepense, Sorghum bicolor, Rottboellia, Cyperus, Abutilon, Sida, Xanthium, Amaranthus, Chenopodium, Ipomoea, Chrysanthemum, Galium, Viola and Veronica.

Areas of cultivation include the areas of ground on which the crop plants are already growing or which have been sown with the seed material of those crop plants, as well as ground intended for the cultivation of such crop plants.

Depending on the intended use, a safener of formula 3.1 to 3.16 can be used in the pretreatment of the seed material of the crop plant (dressing of the seeds or cuttings) or can be introduced into the soil before or after sowing. It can, however, also be applied, either alone (so-called “split application”) or together with the herbicide, after emergence of the plants. The treatment of the plants or seeds with the safener can therefore in principle be carried out independently of the time at which the herbicide is applied but implies a period of time in which herbicide and safener are still able to meet in order that the safening action can subsequently come about at all. So-called “split application” must be distinguished from separate application. The plants can, however, also be treated by simultaneous application of herbicide and safener (e.g. in the form of a tank mixture). The ratio of the rate of application of safener to the rate of application of herbicide depends largely on the method of application. In the case of field treatment, which is carried out either using a tank mixture comprising a combination of safener and herbicide or by separate application of safener and herbicide, the ratio of herbicides to safener is generally from 100:1 to 1:10, preferably from 20:1 to 1:1. In the case of field treatment it is usual to apply from 0.001 to 1.0 kg of safener per ha, preferably from 0.001 to 0.25 kg of safener per ha.

The rate of application of herbicides is generally from 0.001 to 2 kg per ha, but preferably from 0.005 to 0.5 kg per ha.

The compositions according to the invention are suitable for all methods of application conventionally used in agriculture, e.g. pre-emergence application, post-emergence application and seed dressing.

In the case of seed dressing, generally from 0.001 to 10 g of safener per kg of seed, preferably from 0.05 to 2 g of safener per kg of seed, are applied. When the safener is applied in liquid form shortly before sowing, with soaking of the seeds, then advantageously the safener solutions used contain the active ingredient in a concentration of from 1 to 10 000 ppm, preferably from 100 to 1000 ppm.

For the purpose of application, the safeners of formulae 3.1 to 3.16 or combinations of those safeners with a herbicide of formula I and optionally one or more herbicides selected from the co-herbicides under b) are advantageously formulated together with adjuvants customary in formulation technology, e.g. into emulsifiable concentrates coatable pastes, directly sprayable or dilutable solutions, dilute emulsions, wettable powders, soluble powders, dusts, granules or microcapsules.

Such formulations are described, for example, in WO 97/34485, pages 9 to 13. The formulations are prepared in known manner, e.g. by intimately mixing and/or grinding the active ingredients with liquid or solid formulation adjuvants, e.g. solvents or solid carriers. In addition, surface-active compounds (surfactants) can also be used in the preparation of the formulations. Solvents and solid carriers suitable for that purpose are mentioned, for example, in WO 97/34485, on page 6.

Depending on the nature of the compound of formula I, the co-herbicides under b) and the safeners of formulae 3.1 to 3.16 to be formulated, there come into consideration as surface-active compounds non-ionic, cationic and/or anionic surfactants and surfactant mixtures having good emulsifying, dispersing and wetting properties. Examples of suitable anionic, non-ionic and cationic surfactants are listed, for example, in WO 97/34485 on pages 7 and 8. Also suitable for the preparation of the herbicidal compositions according to the invention are the surfactants conventionally employed in formulation technology, which are described, inter alia, in “McCutcheon's Detergents and Emulsifiers Annual” MC Publishing Corp., Ridgewood N.J., 1981, Stache, H., “Tensid-Taschenbuch”, Carl Hanser Verlag, Munich/Vienna, 1981 and M. and J. Ash, “Encyclopedia of Surfactants”, Vol. I-III, Chemical Publishing Co., New York, 1980-81.

The herbicidal formulations usually contain from 0.1 to 99% by weight, especially from 0.1 to 95% by weight, of active ingredient mixture comprising a compound of formula I, a compound selected from the co-herbicides under b) and the safeners of formulae 3.1 to 3.16 from 1 to 99.9% by weight of a sold or liquid formulation adjuivant and from 0 to 25% by weight, especially from 0.1 to 25% by weight, of a surfactant. Whereas commercial products preferably will usually be formulated as concentrates, the end user will normally employ dilute formulations.

The compositions may also comprise further ingredients, such as stabilisers, e.g. vegetable oils or epoxidised vegetable oils (epoxidised coconut oil, rapeseed oil or soybean oil), anti-foams, e.g. silicone oil, preservatives, viscosity regulators, binders, tackifiers, and also fertilisers or other active ingredients. For the use of safeners of formulae 3.1 to 3.16, or of compositions comprising them, in the protection of crop plants against the damaging effects of herbicides of formula I and co-herbicides under b), various methods and techniques come into consideration, such as, for example, the following:

i) Seed Dressing

a) Dressing of the seeds with a wettable powder formulation of a compound from formulae 3.1 to 3.16 by shaking in a vessel until uniformly distributed over the seed surface (dry dressing). In that procedure approximately from 1 to 500 g of a compound from formulae 3.1 to 3.16 (4 g to 2 kg of wettable powder) are used per 100 kg of seed material.

b) Dressing of the seeds with an emulsifiable concentrate of a compound from formulae 3.1 to 3.16 according to method a) (wet dressing).

c) Dressing by immersing the seed material for from 1 to 72 hours in a liquor comprising from 100 to 1000 ppm of a compound from formulae 3.1 to 3.16 and optionally subsequently drying the seeds (immersion dressing).

Dressing the seed material or treating the germinated seedling are naturally the preferred methods of application, because treatment with the active ingredients is directed entirely at the target crop. Generally from 1 to 1000 g of antidote, preferably from 5 to 250 g of antidote, are used per 100 kg of seed material, but depending on the methodology, which also allows other active ingredients or micronutrients to be added, concentrations above or below the limits indicated may be employed (repeat dressing).

ii) Application as a Tank Mixture

A liquid formulation of a mixture of antidote and herbicide is used (ratio by weight of the one to the other from 10:1 to 1:100), the rate of application of herbicide being from 0.005 to 5.0 kg per hectare. Such tank mixtures are applied before or after sowing.

iii) Application to the Seed Furrow

The compound from formulae 3.1 to 3.16 is introduced into the open, sown seed furrow in the form of an emulsifiable concentrate, wettable powder of granules. Once the seed furrow has been covered over, the herbicide is applied in the usual manner pre-emergence.

iv) Controlled Release of Active Ingredient

The compound from formulae 3.1 to 3.16 is applied in solution to mineral carrier granules or polymerised granules (urea/formaldehyde) and dried. If desired, it is also possible to apply a coating that allows the active ingredient to be released in metered amounts over a specific period of time (coated granules).

Preferred formulations have especially the following compositions:
(%=percent by weight)

Emulsifiable Concentrates:

| | |
|---|---|
| active ingredient mixture: | 1 to 90%, preferably 5 to 20% |
| surfactant: | 1 to 30%, preferably 10 to 20% |
| liquid carrier: | 5 to 94%, preferably 70 to 85% |

Dusts:

| | |
|---|---|
| active ingredient mixture: | 0.1 to 10%, preferably 0.1 to 5% |
| solid carrier: | 99.9 to 90%, preferably 99.9 to 99% |

Suspension Concentrates:

| | |
|---|---|
| active ingredient mixture: | 5 to 75%, preferably 10 to 50% |
| water: | 94 to 24%, preferably 88 to 30% |
| surfactant: | 1 to 40%, preferably 2 to 30% |

Wettable Powders:

| | |
|---|---|
| active ingredient mixture: | 0.5 to 90%, preferably 1 to 80% |
| surfactant: | 0.5 to 20%, preferably 1 to 15% |
| solid carrier: | 5 to 95%, preferably 15 to 90% |

Granules:

| | |
|---|---|
| active ingredient mixture: | 0.1 to 30%, preferably 0.1 to 15% |
| solid carrier: | 99.5 to 70%, preferably 97 to 85% |

The following Examples illustrate the invention further, but do not limit the invention.

Formulation Examples for mixtures of herbicides of formula I, optionally of co-herbicides b), and safeners of formulae 3.1 to 3.16 (%=percent by weight)

| F1. Emulsifiable concentrates | a) | b) | c) | d) |
|---|---|---|---|---|
| active ingredient mixture | 5% | 10% | 25% | 50% |
| calcium dodecylbenzenesulfonate | 6% | 8% | 6% | 8% |
| castor oil polyglycol ether | 4% | — | 4% | 4% |
| (36 mol of ethylene oxide) | | | | |
| octylphenol polyglycol ether | — | 4% | — | 2% |
| (7-8 mol of ethylene oxide) | | | | |
| cyclohexanone | — | — | 10% | 20% |
| arom. hydrocarbon mixture | 85% | 78% | 55% | 16% |
| C₉-C₁₂ | | | | |

Emulsions of any desired concentration can be obtained from such concentrates by dilution with water.

| F2. Solutions | a) | b) | c) | d) |
|---|---|---|---|---|
| active ingredient mixture | 5% | 10% | 50% | 90% |
| 1-methoxy-3-(3-methoxy- | — | 20% | 20% | — |
| propoxy)-propane | | | | |
| polyethylene glycol MW 400 | 20% | 10% | — | — |
| N-methyl-2-pyrrolidone | — | — | 30% | 10% |
| arom. hydrocarbon mixture | 75% | 60% | — | — |
| C₉-C₁₂ | | | | |

The solutions are suitable for use in the form of microdrops.

| F3. Wettable powders | a) | b) | c) | d) |
|---|---|---|---|---|
| active ingredient mixture | 5% | 25% | 50% | 80% |
| sodium lignosulfonate | 4% | — | 3% | — |
| sodium lauryl sulfate | 2% | 3% | — | 4% |
| sodium diisobutylnaphthalene- | — | 6% | 5% | 6% |
| sulfonate | | | | |
| octylphenol polyglycol ether | — | 1% | 2% | — |
| (7-8 mol of ethylene oxide) | | | | |
| highly dispersed silicic acid | 1% | 3% | 5% | 10% |
| kaolin | 88% | 62% | 35% | — |

The active ingredient is mixed thoroughly with the adjuvants and the mixture is thoroughly ground in a suitable mill, affording wettable powders which can be diluted with water to give suspensions of any desired concentration.

| F4. Coated granules | a) | b) | c) |
|---|---|---|---|
| active ingredient mixture | 0.1% | 5% | 15% |
| highly dispersed silicic acid | 0.9% | 2% | 2% |
| inorganic carrier | 99.0% | 93% | 83% |
| (diameter 0.1-1 mm) | | | |
| e.g. CaCO₃ or SiO₂ | | | |

The active ingredient is dissolved in methylene chloride and applied to the carrier by spraying, and the solvent is then evaporated off in vacuo.

| F5. Coated granules | a) | b) | c) |
|---|---|---|---|
| active ingredient mixture | 0.1% | 5% | 15% |
| polyethylene glycol MW 200 | 1.0% | 2% | 3% |
| highly dispersed silicic acid | 0.9% | 1% | 2% |
| inorganic carrier | 98.0% | 92% | 80% |
| (diameter 0.1-1 mm) | | | |
| e.g. CaCO₃ or SiO₂ | | | |

The finely ground active ingredient is uniformly applied, in a mixer, to the carrier moistened with polyethylene glycol. Non-dusty coated granules are obtained in this manner.

| F6. Extruder granules | a) | b) | c) | d) |
|---|---|---|---|---|
| active ingredient mixture | 0.1% | 3% | 5% | 15% |
| sodium lignosulfonate | 1.5% | 2% | 3% | 4% |
| carboxymethylcellulose | 1.4% | 2% | 2% | 2% |
| kaolin | 97.0% | 93% | 90% | 79% |

The active ingredient is mixed and ground with the adjuvants, and the mixture is moistened with water. The mixture is extruded and then dried in a stream of air.

| F7. Dusts | a) | b) | c) |
|---|---|---|---|
| active ingredient mixture | 0.1% | 1% | 5% |
| talcum | 39.9% | 49% | 35% |
| kaolin | 60.0% | 50% | 60% |

Ready-to-use dusts are obtained by mixing the active ingredient with the carriers and grinding the mixture in a suitable mill.

| F8. Suspension concentrates | a) | b) | c) | d) |
|---|---|---|---|---|
| active ingredient mixture | 3% | 10% | 25% | 50% |
| ethylene glycol | 5% | 5% | 5% | 5% |
| nonylphenol polyglycol ether | — | 1% | 2% | — |
| (15 mol of ethylene oxide) | | | | |
| sodium lignosulfonate | 3% | 3% | 4% | 5% |
| carboxymethylcellulose | 1% | 1% | 1% | 1% |
| 37% aqueous formaldehyde | 0.2% | 0.2% | 0.2% | 0.2% |
| solution | | | | |
| silicone oil emulsion | 0.8% | 0.8% | 0.8% | 0.8% |
| water | 87% | 79% | 62% | 38% |

The finely ground active ingredient is intimately mixed with the adjuvants, giving a suspension concentrate from which suspensions of any desired concentration can be obtained by dilution with water.

It is often more practical for the compounds of formula I, co-herbicides under b) and the safeners of formulae 3.1 to 3.16 to be formulated separately and then to be brought together in the desired mixing ratio in the applicator in the form of a “tank mixture” in water shortly before application.

The ability of the safeners of formulae 3.1 to 3.16 to protect crop plants against the phytotoxic action of herbicides of formula I is illustrated in the following Examples.

### BIOLOGICAL EXAMPLE

### Safening Action

The test plants are grown in plastics pots under greenhouse conditions to the 4-leaf stage. At that stage, either the herbicides alone or the mixtures of the herbicides with the test compounds being tested as safeners are applied to the test plants. The test compounds are applied in the form of an aqueous suspension prepared from a 25% wettable powder (Example F3, b)), using 500 litres of water per ha. 4 weeks after application, the phytotoxic action of the herbicides on the crop plants, e.g. maize and cereals, is evaluated using a percentage scale. 100% indicates that the test plant has died, 0% indicates no phytotoxic action. The mixtures according to the invention exhibit a good action in this test.

1. A selectively herbicidal composition that, in addition to comprising customary inert formulation adjuvants, comprises as active ingredient a mixture of
a) a herbicidally effective amount of a compound of formula I 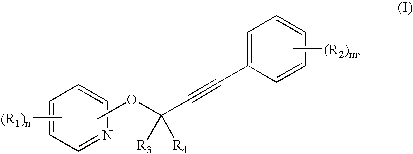
wherein
n is 0, 1, 2, 3 or 4;
each R₁ independently is halogen, —CN, —SCN, —SF₅, —NO₂, —NR₅R₆, —CO₂R₇, —CONR₈R₉, —C(R₁₀)═NOR₁₁, —COR₁₂, —OR₁₃, —SR₁₄, —SOR₁₅, —SO₂R₁₆, —OSO₂R₁₇, C₁-C₈alkyl, C₂-C₈alkenyl, C₂-C₈alkynyl or C₃-C₆cycloalkyl; or is C₁-C₈alkyl, C₂-C₈alkenyl or C₂-C₈alkynyl mono- or poly-substituted by halogen, —CN, —NO₂, —NR₁₈R₁₉, —CO₂R₂₀, —CONR₂₁R₂₂, —COR₂₃, —C(R₂₄)═NOR₂₅, —C(S)NR₂₆R₂₇, —C(C₁-C₄alkylthio)=NR₂₈, —OR₂₉, —SR₃₀, —SOR₃₁, —SO₂R₃₂ or by C₃-C₆cycloalkyl; or
each R₁ is C₃-C₆cycloalkyl mono- or poly-substituted by halogen, —CN, —NO₂, —NR₁₈R₁₉, —CO₂R₂₀, —CONR₂₁R₂₂, —COR₂₃, —C(R₂₄)═NOR₂₅, —C(S)NR₂₆R₂₇, —C(C₁-C₄alkylthio)=NR₂₈, —SR₃₀, —SOR₃₁, —SO₂R₃₂ or by C₃-C₆cycloalkyl; or
each R₁ independently is phenyl, which may in turn be mono- or poly-substituted by halogen, C₁-C₄alkyl, C₁-C₄haloalkyl, C₁-C₄alkoxy, —CN, —NO₂, C₁-C₄alkylthio, C₁-C₄alkylsulfinyl or by C₁-C₄alkylsulfonyl; or
two adjacent R₁ substituents together form a C₁-C₇alkylene bridge which may be interrupted by 1 or 2 non-adjacent oxygen atoms and substituted by C₁-C₆alkyl, the total number of ring atoms being at least 5 and at most 9; or two adjacent R₁ substituents together form a C₂-C₇alkenylene bridge which may be interrupted by 1 or 2 non-adjacent oxygen atoms and substituted by C₁-C₆alkyl, the total number of ring atoms being at least 5 and at most 9;
R₃ and R₄ are each independently of the other hydrogen, halogen, —CN, C₁-C₄alkyl or C₁-C₄alkoxy; or
R₃ and R₄ together are C₂-C₅alkylene;
R₅ is hydrogen or C₁-C₈alkyl;
R₆ is hydrogen, C₁-C₈alkyl, C₃-C₈alkenyl, C₃-C₈alkynyl, phenyl or benzyl; it being possible for phenyl and benzyl in turn to be mono- or poly-substituted by halogen, C₁-C₄alkyl, C₁-C₄halo-alkyl, C₁-C₄alkoxy, —CN, —NO₂, C₁-C₄alkylthio, C₁-C₄alkylsulfinyl or by C₁-C₄alkylsulfonyl; or
R₅and R₆ together are a C₂-C₅alkylene chain which may be interrupted by an oxygen or sulfur atom; R₇ is hydrogen, C₁-C₈alkyl, C₂-C₈alkenyl or C₃-C₈alkynyl, or is C₁-C₈alkyl, C₃-C₈alkenyl or C₃-C₈alkynyl mono- or poly-substituted halogen, C₁-C₄alkoxy or by phenyl, it being possible for phenyl in turn to be mono- or poly-substituted by halogen, C₁-C₄alkyl, C₁-C₄-halo-alkyl, C₁-C₄alkoxy, —CN, —NO₂, C₁-C₄alkylthio, C₁-C₄alkylsulfinyl or by C₁-C₄alkylsulfonyl;
R₈ is hydrogen or C₁-C₈alkyl;
R₉ is hydrogen or C₁-C₈alkyl, or is C₁-C₈alkyl mono- or poly-substituted by COOH, C₁-C₈-alkoxycarbonyl or by —CN, or
R₉ is C₃-C₈alkenyl, C₃-C₈alkynyl, phenyl or benzyl, it being possible for phenyl and benzyl in turn to be mono- or poly-substituted by halogen, C₁-C₄alkyl, C₁-C₄haloalkyl, C₁-C₄alkoxy, —CN, —NO₂, C₁-C₄alkylthio, C₁-C₄alkylsulfinyl or by C₁-C₄alkylsulfonyl; or
R₈ and R₉ together are C₂-C₅alkylene;
R₁₀ is hydrogen, C₁-C₄alkyl, C₁-C₄haloalkyl or C₃-C₆cycloalkyl;
R₁₁ is hydrogen, C₁-C₈alkyl, C₃-C₈alkenyl, C₃-C₈alkynyl, C₁-C₄haloalkyl or C₃-C₆haloalkenyl;
R₁₂ is hydrogen, C₁-C₄alkyl, C₁-C₄haloalkyl or C₃-C₆cycloalkyl;
R₁₃ is hydrogen, C₁-C₈alkyl, C₃-C₈alkenyl or C₃-C₈alkynyl; or
R₁₃ is phenyl or phenyl-C₁-C₆alkyl, it being possible for the phenyl ring in turn to be mono- or poly-substituted by halogen, C₁-C₄alkyl, C₁-C₄haloalkyl, C₁-C₄alkoxy, —CN, —NO₂ or by —S(O)₂C₁-C₈alkyl, or
R₁₃ is C₁-C₈alkyl mono- or poly-substituted by halogen, —CN or by C₁-C₄alkoxy;
R₁₄ is hydrogen, C₁-C₈alkyl, C₃-C₈alkenyl or C₃-C₈alkynyl, or is C₁-C₈alkyl mono- or poly-substituted by halogen, —CN or by C₁-C₄alkoxy;
R₁₅, R₁₆ and R₁₇ are each independently of the others C₁-C₈alkyl, C₃-C₈alkenyl or C₃-C₈-alkynyl, or C₁-C₈alkyl mono- or poly-substituted by halogen, —CN or by C₁-C₄alkoxy;
R₁₈ is hydrogen or C₁-C₈alkyl;
R₁₉ is hydrogen, C₁-C₈alkyl, C₃-C₈alkenyl, C₃-C₈alkynyl, phenyl or benzyl, it being possible for phenyl and benzyl in turn to be mono- or poly-substituted by halogen, C₁-C₄alkyl, C₁-C₄halo-alkyl, C₁-C₄alkoxy, —CN, —NO₂, C₁-C₄alkylthio, C₁-C₄alkylsulfinyl or by C₁-C₄alkylsulfonyl; or
R₁₈ and R₁₉ together are a C₂-C₅alkylene chain which may be interrupted by an oxygen or sulfur atom;
R₂₀ is hydrogen, C₁-C₈alkyl, C₃-C₈alkenyl, C₃-C₈alkynyl, phenyl or benzyl, it being possible for phenyl and benzyl in turn to be mono- or poly-substituted by halogen, C₁-C₄alkyl, C₁-C₄halo-alkyl, C₁-C₄alkoxy, —CN, —NO₂, C₁-C₄alkylthio, C₁-C₄alkylsulfinyl or by C₁-C₄alkylsulfonyl;
R₂₁ is hydrogen or C₁-C₈alkyl;
R₂₂ is hydrogen or C₁-C₈alkyl, or is C₁-C₈alkyl mono- or poly-substituted by COOH, C₁-C₈-alkoxycarbonyl or by —CN, or
R₂₂ is C₃-C₈alkenyl, C₃-C₈alkynyl, phenyl or benzyl, it being possible for phenyl and benzyl in turn to be mono- or poly-substituted by halogen, C₁-C₄alkyl, C₁-C₄haloalkyl, C₁-C₄alkoxy, —CN, —NO₂, C₁-C₄alkylthio, C₁-C₄alkylsulfinyl or by C₁-C₄alkylsulfonyl; or
R₂₁ and R₂₂ together are C₂-C₅alkylene;
R₂₃ is hydrogen, C₁-C₄alkyl, C₁-C₄haloalkyl or C₃-C₆cycloalkyl;
R₂₄ is hydrogen, C₁-C₄alkyl, C₁-C₄haloalkyl or C₃-C₆cycloalkyl;
R₂₅ is hydrogen, C₁-C₈alkyl, C₃-C₈alkenyl, C₃-C₈alkynyl, C₁-C₄haloalkyl or C₃-C₆haloalkenyl;
R₂₆ is hydrogen or C₁-C₈alkyl;
R₂₇ is hydrogen or C₁-C₈alkyl, or is C₁-C₈alkyl mono- or poly-substituted by COOH, C₁-C₈-alkoxycarbonyl or by —CN, or
R₂₇ is C₃-C₈alkenyl, C₃-C₈alkynyl, phenyl or benzyl, it being possible for phenyl and benzyl in turn to be mono- or poly-substituted by halogen, C₁-C₄alkyl, C₁-C₄haloalkyl, C₁-C₄alkoxy, —CN, —NO₂, C₁-C₄alkylthio, C₁-C₄alkylsulfinyl or by C₁-C₄alkylsulfonyl; or
R₂₆ and R₂₇ together are C₂-C₅alkylene;
R₂₈ is hydrogen or C₁-C₈alkyl;
R₂₉ and R₃₀ are each independently of the other hydrogen, C₁-C₈alkyl, C₃-C₈alkenyl or C₃-C₈alkynyl, or C₁-C₈alkyl mono- or poly-substituted by halogen, —CN or by C₁-C₄alkoxy;
R₃₁ and R₃₂ are each independently of the other C₁-C₈alkyl, C₃-C₈alkenyl or C₃-C₈alkynyl, or
C₁-C₈alkyl mono- or poly-substituted by halogen, —CN or by C₁-C₄alkoxy;
m is 0, 1, 2, 3, 4 or 5;
each R₂ independently is halogen, —CN, —SCN, —SF₅, —NO₂, —NR₃₆R₃₇, —CO₂R₃₈, —CONR₃₉R₄₀, —C(R₄₁)═NOR₄₂, —COR₄₃, —OR₄₄, —SR₄₅, —SOR₄₆, —SO₂R₄₇, OSO₂R₄₈—N([CO]ₚR₄₉)COR₅₀, —N(OR₅₁)COR₅₂, —N(R₅₃)CO₂R₅₄ or —N-phthalimide;
R₃₆ is hydrogen or C₁-C₈alkyl; and
R₃₇ is hydrogen, C₁-C₈alkyl, C₃-C₈alkenyl, C₃-C₈alkynyl, phenyl or benzyl, it being possible for phenyl and benzyl in turn to be mono- or poly-substituted by halogen, C₁-C₄alkyl, C₁-C₄halo-alkyl, C₁-C₄alkoxy, —CN, —NO₂, C₁-C₄alkylthio, C₁-C₄alkylsulfinyl or by C₁-C₄alkylsulfonyl; or
R₃₆ and R₃₇ together are a C₂-C₅alkylene chain which may be interrupted by an oxygen or sulfur atom;
R₃₈ is hydrogen, C₁-C₈alkyl, C₃-C₈alkenyl or C₃-C₈alkynyl, or is C₁-C₈alkyl, C₃-C₈alkenyl or C₃-C₈alkynyl mono- or poly-substituted by halogen, C₁-C₄alkoxy or by phenyl, it being possible for phenyl in turn to be mono- or poly-substituted by halogen, C₁-C₄alkyl, C₁-C₄halo-alkyl C₁-C₄alkoxy, —CN, —NO₂, C₁-C₄alkylthio, C₁-C₄alkylsulfinyl or by C₁-C₄alkylsulfonyl;
R₃₉ is hydrogen or C₁-C₈alkyl;
R₄₀ is hydrogen or C₁-C₈alkyl, or is C₁-C₈alkyl mono- or poly-substituted by —COOH, C₁-C₈-alkoxycarbonyl or by —CN, or
R₄₀ is C₃-C₈alkenyl, C₃-C₈alkynyl, phenyl or benzyl, it being possible for phenyl and benzyl in turn to be mono- or poly-substituted by halogen, C₁-C₄alkyl, C₁-C₄haloalkyl, C₁-C₄alkoxy, —CN, —NO₂, C₁-C₄alkylthio, C₁-C₄alkylsulfinyl or by C₁-C₄alkylsulfonyl; or
R₃₉ and R₄₀ together are C₃-C₅alkylene;
R₄₁ is hydrogen, C₁-C₄alkyl, C₁-C₄haloalkyl or C₃-C₆cycloalkyl;
R₄₂ is hydrogen, C₁-C₈alkyl, C₃-C₈alkenyl, C₃-C₈alkynyl, C₁-C₄haloalkyl or C₃-C₆haloalkenyl;
R₄₃ is hydrogen, C₁-C₄alkyl, C₁-C₄haloalkyl or C₃-C₆cycloalkyl;
R₄₄ is hydrogen, C₁-C₈alkyl, C₃-C₈alkenyl or C₃-C₈alkynyl; or
R₄₄ is phenyl or phenyl-C₁-C₆alkyl, it being possible for the phenyl ring in turn to be mono- or poly-substituted by halogen, C₁-C₄alkyl, C₁-C₄haloalkyl, C₁-C₄alkoxy, —CN, —NO₂ or by —S(O)₂C₁-C₈alkyl, or
R₄₄ is C₁-C₈alkyl mono- or poly-substituted by halogen, —CN or by C₁-C₄alkoxy;
R₄₅ is hydrogen, C₁-C₈alkyl, C₃-C₈alkenyl or C₃-C₈alkynyl, or is C₁-C₈alkyl mono- or poly-substituted by halogen, —CN or by C₁-C₄alkoxy;
R₄₆, R₄₇ and R₄₈ are each independently of the others C₁-C₈alkyl, C₃-C₈alkenyl or C₃-C₈-alkynyl, or C₁-C₈alkyl mono- or poly-substituted by halogen, —CN or by C₁-C₄alkoxy;
p is 0 or 1;
R₄₉, R₅₀, R₅₁, R₅₂, R₅₃ and R₅₄ are each independently of the others hydrogen, C₁-C₈alkyl, or phenyl which may in turn be mono- or poly-substituted by halogen, C₁-C₈alkyl, C₁-C₄halo-alkyl, C₁-C₄alkoxy, —CN, —NO₂, C₁-C₈alkylthio, C₁-C₈alkylsulfinyl or by C₁-C₈alkylsulfonyl; or
each R₂ independently is C₁-C₈alkyl, or is C₁-C₈alkyl mono- or poly-substituted by halogen, —CN, —NO₂, —NR₅₅R₅₆, —CO₂R₅₇, —CONR₅₈R₅₉, —COR₆₀, —C(R₆₁)═NOR₆₂, —C(S)NR₆₃R₆₄, —C(C₁-C₄alkylthio)=NR₆₅, —OR₆₆, —SR₆₇, —SOR₆₈, —SO₂R₆₉, —O(SO₂)R₇₀, —N(R₇₁)CO₂R₇₂, —N(R₇₃)COR₇₄ or by C₃-C₆cycloalkyl; or
each R₂ independently is C₂-C₈alkenyl, or is C₂-C₈alkenyl mono- or poly-substituted by —CN, —NO₂, —CO₂R₇₅, —CONR₇₆R₇₇, —COR₇₈, —C(R₇₉)═NOR₈₀, —C(S)NR₈₁R₈₂, —C(C₁-C₄alkylthio)=NR₈₃ or by C₃-C₆cycloalkyl; or
each R₂ independently is C₂-C₈alkynyl, or is C₂-C₈alkynyl mono- or poly-substituted by halogen, —CN, —CO₂R₈₄, —CONR₈₅R₈₆, —COR₈₇, —C(R₈₈)═NOR₈₉, —C(S)NR₉₀R₉₁, —C(C₁-C₄alkylthio)=NR₉₂ or by C₃-C₆cycloalkyl; or
each R₂ independently is C₃-C₆cycloalkyl, or is C₃-C₆cycloalkyl mono- or poly-substituted by halogen, —CN, —CO₂R₉₃, —CONR₉₄R₉₅, —COR₉₆, —C(R₉₇)═NOR₉₈, —C(S)NR₉₉R₁₀₀ or by —C(C₁-C₄alkylthio)=NR₁₀₁; or
two adjacent R₂ substituents together form a C₁-C₇alkylene bridge which may be interrupted by 1 or 2 non-adjacent oxygen atoms and substituted by C₁-C₆alkyl, the total number of ring atoms being at least 5 and at most 9; or two adjacent R₂ substituents together form a C₁-C₇alkenylene bridge which may be interrupted by 1 or 2 non-adjacent oxygen atoms and substituted by C₁-C₆alkyl, the total number of ring atoms being at least 5 and at most 9;
R₅₅ is hydrogen or C₁-C₈alkyl;
R₅₆ is hydrogen, C₁-C₈alkyl, C₃-C₈alkenyl, C₃-C₈alkynyl, phenyl or benzyl, it being possible for phenyl and benzyl in turn to be mono- or poly-substituted by halogen, C₁-C₄alkyl, C₁-C₄halo-alkyl, C₁-C₄alkoxy, —CN, —NO₂, C₁-C₄alkylthio, C₁-C₄alkylsulfinyl or by C₁-C₄alkylsulfonyl; or
R₅₅ and R₅₆ together are a C₂-C₅alkylene chain which may be interrupted by an oxygen or sulfur atom;
R₅₇ is hydrogen, C₁-C₈alkyl, C₃-C₈alkenyl or C₃-C₈alkynyl, or is C₁-C₈alkyl, C₃-C₈alkenyl or C₃-C₈alkynyl mono- or poly-substituted by halogen, C₁-C₄alkoxy or by phenyl, it being possible for phenyl in turn to be mono- or poly-substituted by halogen, C₁-C₄alkyl, C₁-C₄halo-alkyl, C₁-C₄alkoxy, —CN, —NO₂, C₁-C₄alkylthio, C₁-C₄alkylsulfinyl or by C₁-C₄alkylsulfonyl;
R₅₈ is hydrogen or C₁-C₈alkyl;
R₅₉ is hydrogen or C₁-C₈alkyl, or is C₁-C₈alkyl mono- or poly-substituted by —COOH, C₁-C₈-alkoxycarbonyl or by —CN; or
R₅₉ is C₃-C₈alkenyl, C₃-C₈alkynyl, phenyl or benzyl, it being possible for phenyl and benzyl in turn to be mono- or poly-substituted by halogen, C₁-C₄alkyl, C₁-C₄haloalkyl, C₁-C₄alkoxy, —CN, —NO₂, C₁-C₄alkylthio, C₁-C₄alkylsulfinyl or by C₁-C₄alkylsulfonyl; or
R₅₈ and R₅₉ together are C₂-C₅alkylene;
R₆₀ is hydrogen, C₁-C₄alkyl, C₁-C₄haloalkyl or C₃-C₆cycloalkyl;
R₆₁ is hydrogen, C₁-C₄alkyl, C₁-C₄haloalkyl or C₃-C₆cycloalkyl;
R₆₂ is hydrogen, C₁-C₈alkyl, C₃-C₈alkenyl, C₃-C₈alkynyl, C₁-C₄haloalkyl or C₃-C₆haloalkenyl; and
R₆₃ is hydrogen or C₁-C₈alkyl;
R₆₄ is hydrogen or C₁-C₈alkyl, or is C₁-C₈alkyl mono- or poly-substituted by —COOH, C₁-C₈-alkoxycarbonyl or by —CN; or
R₆₄ is C₃-C₈alkenyl, C₃-C₈alkenyl, phenyl or benzyl, it being possible for phenyl and benzyl in turn to be mono- or poly-substituted by halogen, C₁-C₄alkyl, C₁-C₄haloalkyl, C₁-C₄alkoxy, —CN, —NO₂, C₁-C₄alkylthio, C₁-C₄alkylsulfinyl or by C₁-C₄alkylsulfonyl; or
R₆₃ and R₆₄ together are C₂-C₅alkylene;
R₆₅ is hydrogen or C₁-C₈alkyl;
R₆₆ and R₆₇ are each independently of the other hydrogen, C₁-C₈alkyl, C₃-C₈alkenyl, C₃-C₈alkynyl, or C₁-C₈alkyl mono- or poly-substituted by halogen, —CN or by C₁-C₄alkoxy;
R₆₈ R₆₉ and R₇₀ are each independently of the other C₁-C₈alkyl, C₃-C₈alkenyl or C₃-C₈alkynyl, or C₁-C₈alkyl mono- or poly-substituted by halogen, —CN or by C₁-C₄alkoxy;
R₇₁ and R₇₃ are each independently of the other hydrogen, C₁-C₈alkyl or C₁-C₈alkoxy;
R₇₂ is C₁-C₈alkyl;
R₇₄ is hydrogen or C₁-C₈alkyl;
R₇₅ is hydrogen, or is C₁-C₈alkyl, C₃-C₈alkenyl or C₃-C₈alkynyl, each of which may be mono- or poly-substituted by halogen, C₁-C₄alkoxy or by phenyl, it being possible for phenyl in turn to be mono- or poly-substituted by halogen, C₁-C₄alkyl, C₁-C₄haloalkyl, C₁-C₄alkoxy, —CN, —NO₂, C₁-C₄alkylthio, C₁-C₄alkylsulfinyl or by C₁-C₄alkylsulfonyl;
R₇₆ is hydrogen or C₁-C₈alkyl;
R₇₇ is hydrogen or C₁-C₈alkyl, or is C₁-C₈alkyl mono- or poly-substituted by —COOH, C₁-C₈-alkoxycarbonyl or by —CN; or
R₇₇ is C₃-C₈alkenyl, C₃-C₈alkynyl, phenyl or benzyl, it being possible for phenyl and benzyl in turn to be mono- or poly-substituted by halogen, C₁-C₄alkyl, C₁-C₄haloalkyl, C₁-C₄alkoxy, —CN, —NO₂, C₁-C₄alkylthio, C₁-C₄alkylsulfinyl or by C₁-C₄alkylsulfonyl; or
R₇₆ and R₇₇ together are C₂-C₅alkylene;
R₇₈ and R₇₉ are each independently of the other hydrogen, C₁-C₄alkyl, C₁-C₄haloalkyl or C₃-C₆cycloalkyl;
R₈₀ is hydrogen, C₁-C₈alkyl, C₃-C₈alkenyl, C₃-C₈alkynyl, C₁-C₄haloalkyl or C₃-C₆haloalkenyl;
R₈₁ is hydrogen or C₁-C₈alkyl;
R₈₂ is hydrogen or C₁-C₈alkyl, or is C₁-C₈alkyl mono- or poly-substituted by —COOH, C₁-C₈-alkoxycarbonyl or by —CN; or
R₈₂ is C₃-C₈alkenyl, C₃-C₈alkynyl, phenyl or benzyl, it being possible for phenyl and benzyl in turn to be mono- or poly-substituted by halogen, C₁-C₄alkyl, C₁-C₄haloalkyl, C₁-C₄alkoxy, —CN, —NO₂, C₁-C₄alkylthio, C₁-C₄alkylsulfinyl or by C₁-C₄alkylsulfonyl; or
R₈₁ and R₈₂ together are C₂-C₅alkylene;
R₈₃ is hydrogen or C₁-C₈alkyl;
R₈₄ is hydrogen or is C₁-C₈alkyl, C₃-C₈alkenyl or C₃-C₈alkynyl, each of which may be mono- or poly-substituted by halogen, C₁-C₄alkoxy or by phenyl, it being possible for phenyl in turn to be mono- or poly-substituted by halogen, C₁-C₄alkyl, C₁-C₄haloalkyl, C₁-C₄alkoxy, —CN, —NO₂, C₁-C₄alkylthio, C₁-C₄alkylsulfinyl or by C₁-C₄alkylsulfonyl;
R₈₅ is hydrogen or C₁-C₈alkyl;
R₈₆ is hydrogen or C₁-C₈alkyl, or is C₁-C₈alkyl mono- or poly-substituted by —COOH, C₁-C₈-alkoxycarbonyl or by —CN; or
R₈₆ is C₃-C₈alkenyl, C₃-C₈alkynyl, phenyl or benzyl, it being possible for phenyl and benzyl in turn to be mono- or poly-substituted by halogen, C₁-C₄alkyl, C₁-C₄haloalkyl, C₁-C₄alkoxy, —CN, —NO₂, C₁-C₄alkylthio, C₁-C₄alkylsulfinyl or by C₁-C₄alkylsulfonyl; or
R₈₅ and R₈₆ together are C₂-C₅alkylene;
R₈₇ is hydrogen, C₁-C₄alkyl, C₁-C₄haloalkyl or C₃-C₆cycloalkyl;
R₈₈ is hydrogen, C₁-C₄alkyl, C₁-C₄haloalkyl or C₃-C₆cycloalkyl;
R₈₉ is hydrogen, C₁-C₈alkyl, C₃-C₈alkenyl, C₃-C₈alkynyl, C₁-C₄haloalkyl or C₃-C₆haloalkenyl;
R₉₀ is hydrogen or C₁-C₈alkyl;
R₉₁ is hydrogen or C₁-C₈alkyl, or is C₁-C₈alkyl mono- or poly-substituted by —COOH, C₁-C₈-alkoxycarbonyl or by —CN; or
R₉₁ is C₃-C₈alkenyl, C₃-C₈alkynyl, phenyl or benzyl, it being possible for phenyl and benzyl in turn to be mono- or poly-substituted by halogen, C₁-C₄alkyl, C₁-C₄haloalkyl, C₁-C₄alkoxy, —CN, —NO₂, C₁-C₄alkylthio, C₁-C₄alkylsulfinyl or by C₁-C₄alkylsulfonyl; or
R₉₀ and R₉₁ together are C₂-C₅alkylene;
R₉₂ is hydrogen or C₁-C₈alkyl;
R₉₃ is hydrogen, or is C₁-C₈alkyl, C₃-C₈alkenyl or C₃-C₈alkynyl, each of which may be mono- or poly-substituted by halogen, C₁-C₄alkoxy or by phenyl, it being possible for phenyl in turn to be mono- or poly-substituted by halogen, C₁-C₄alkyl, C₁-C₄haloalkyl, C₁-C₄alkoxy, —CN, —NO₂, C₁-C₄alkylthio, C₁-C₄alkylsulfinyl or by C₁-C₄alkylsulfonyl;
R₉₄ is hydrogen or C₁-C₈alkyl;
R₉₅ is hydrogen or C₁-C₈alkyl, or is C₁-C₈alkyl mono- or poly-substituted by —COOH, C₁-C₈-alkoxycarbonyl or by —CN; or
R₉₅ is C₃-C₈alkenyl, C₃-C₈alkynyl, phenyl or benzyl, it being possible for phenyl and benzyl in turn to be mono- or poly-substituted by halogen, C₁-C₄alkyl, C₁-C₄haloalkyl, C₁-C₄alkoxy, —CN, —NO₂, C₁-C₄alkylthio, C₁-C₄alkylsulfinyl or by C₁-C₄alkylsulfonyl; or
R₉₄ and R₉₅ together are C₂-C₅alkylene;
R₉₆ is hydrogen, C₁-C₄alkyl, C₁-C₄haloalkyl or C₃-C₆cycloalkyl;
R₉₇ is hydrogen, C₁-C₄alkyl, C₁-C₄haloalkyl or C₃-C₆cycloalkyl;
R₉₈ is hydrogen, C₁-C₈alkyl, C₃-C₈alkenyl, C₃-C₈alkynyl, C₁-C₄haloalkyl or C₃-C₆haloalkenyl;
R₉₉ is hydrogen or C₁-C₈alkyl;
R₁₀₀ is hydrogen or C₁-C₈alkyl, or is C₁-C₈alkyl mono- or poly-substituted by —COOH, C₁-C₈-alkoxycarbonyl or by —CN; or
R₁₀₀ is C₃-C₈alkenyl, C₃-C₈alkynyl, phenyl or benzyl, it being possible for phenyl and benzyl in turn to be mono- or poly-substituted by halogen, C₁-C₄alkyl, C₁-C₄haloalkyl, C₁-C₄alkoxy, —CN, —NO₂, C₁-C₄alkylthio, C₁-C₄alkylsulfinyl or by C₁-C₄alkylsulfonyl; or
R₉₉ and R₁₀₀ together are C₂-C₅alkylene; and
R₁₀₁ is hydrogen or C₁-C₈alkyl,
or an agrochemically acceptable salt or any stereoisomer or tautomer of a compound of formula I, and
b) a synergistically effective amount of one or more compounds selected from the group consisting of the co-herbicides:
triasulfuron (773), prosulfuron (657), clodinafop-propargyl (156), terbutryn (740), dicamba (222), fenoxaprop-P-ethyl (331), metamifop, diclofop-methyl (232), tralkoxydim (767), butroxydim (104), amidosulfuron (24), chlorsulfuron (146), ethoxysulfuron (307), flupyrsulfuron (374), flupyrsulfuron-methyl-sodium (374), metsulfuron-methyl (536), sulfosulfuron (714), thifensulfuron-methyl (754), tribenuron-methyl (778), imazamethabenz-methyl (438), flucarbazone-sodium (357), iodosulfuron-methyl-sodium (454), florasulam (351), flumetsulam (366), metosulam (533), chlorotoluron (142), isoproturon (464), methabenzthiazuron (510), bromoxynil (93), ioxynil (455), pyridate (672), bifenox (75), fluoroglycofen-ethyl (371), carfentrazone-ethyl (119), fluazolate (355), diflufenican (245), flurtamone (382), glyphosate (407), sulfosate (407), glufosinate (406), S-glutosinate, bialaphos (bilanafos; (77)), ethalfluralin (298), pendimethalin (599), 2,4-DB (211), dichlorprop (2,4-DP; (228)), MCPA (485), MCPB (487), mecoprop (MCPP; (489)), mecoprop-P (490), clopyralid (162), fluroxypyr (380), quinmerac (682), benazolin-ethyl (59), difenzoquat metilsulfate (242), cyhalofop-butyl (191), trifluralin (791), fluthiamide (flufenacet; (362)), isoxaben (466), prosulfocarb (656), triallate (772), 2,4-D (205); benfluamid, cinidon-ethyl (152), flufenpyr, picolinafen (Code No. AC 900001; (621)), propoxycarbazone (Code No. MKH 6561; (541));
pretilachlor (632), cinbsulfuron (154) fenclorim (325), pyriftalid (Code No. CGA 279 233), metolachlor (529), S-metolachlor (530), mixtures of metolachlor and S-metolachlor, preferably mixtures thereof containing 50-90% especially 70-90% S-metolachlor, bensulfuron-methyl (66), imazosulfuron (444) pyrazosulfuron-ethyl (665), azimsulfuron (45), esprocarb (296), mefenacet (491), molinate (542), propanil (644), pyrazolate (pyrazolynate; (663)), fenoxaprop-ethyl (“The Pesticide Manual”, Editor C. Tomlin, 10th Edition, British Crop Protection Council, 1994, Entry No. (299)), bispyribac (82), bispyribac-sodium (82), pyriminobac-methyl (676), cafenstrole (108), oxaziclomefone (Code No. MY-100; (583)), dymron (daimuron; (207)), fentrazamide (Code No. NBA 061; (340)), indanofan (Code No. MK243; (450)), etobenzanid (Code No. HW-52; (311)), oxadiargyl (578), halosulfuron-methyl (414), clomazone (159), oxadiazon (579), benzobicyclon (Code No. SAN1315H; (70)), mefenpyr-diethyl (492);
profoxydim (Code No. BAS 625H; (54)), pyrazogyl;
cyclosulfamuron (186), flazasulfuron (349), flufenacet (362), benfuresate (63), bentazone (69), bromobutide (91), dithiopyr (275), ethametsulfuron-methyl (299), flamprop-M (348), methyldymron (521), quinclorac (681), thiazopyr (752) and mesosulfuron.

2. A method of controlling undesired plant growth in a crop of useful plants, which comprises allowing a herbicidally effective amount of a composition according to claim 1 to act on the crop plant or the area of cultivation thereof.

3. A method according to claim 2, wherein the crop plant is a cereal, rice or maize.

4. A method according to claim 2, wherein the crop of useful plants is treated with the said composition at a rate of application corresponding to a total amount of active ingredient of from 1 to 5000 g per hectare.

5. A selectively herbicidal composition that, in addition to comprising customary inert formulation adjuvants, such as carriers, solvents and wetting agents, comprises as active ingredient a mixture of
ab) an amount, effective for herbicide synergism, of a compound of formula I according to claim 1 and one or more compounds selected from the co-herbicides under b) according to claim 1, and
c) an amount for herbicide antagonism, of a compound selected from the compound of formula 3.1

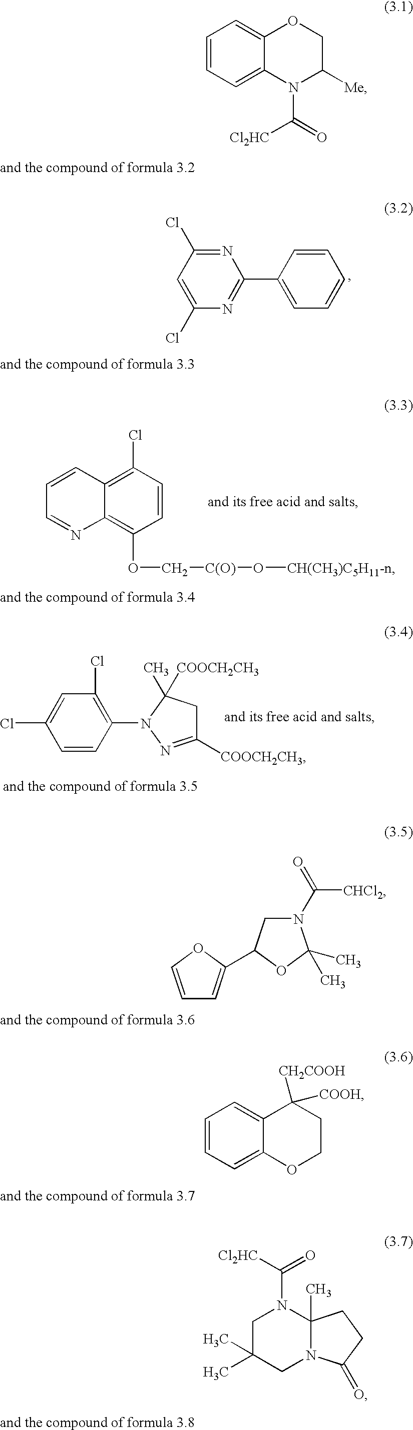

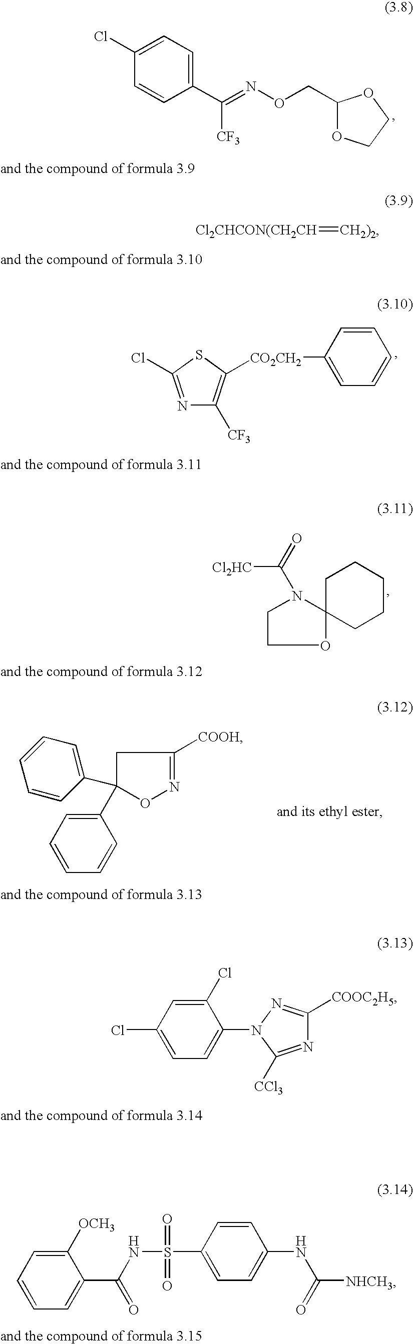

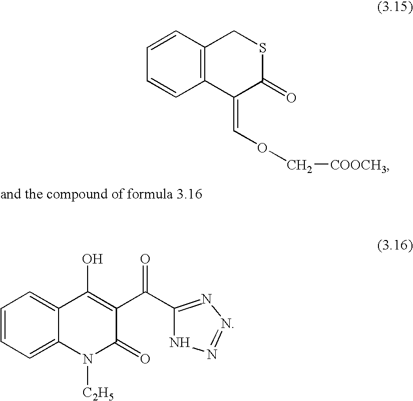

6. A method for the selective control of weeds and grasses in a crop of useful plants, which comprises treating the useful plants, seeds or cuttings thereof, or the area of cultivation thereof, with an amount, effective for herbicide synergism, of a composition according to claim 5.

7. A method according to claim 6, wherein the rate of application of herbicides is from 1 to 5000 g per ha and the rate of application of safener is from 0.001 to 0.5 kg per ha.

8. A method according to claim 6, wherein the crop of useful plants is a cereal, rice or maize.

9. A selectively herbicidal composition that, in addition to comprising customary inert formulation adjuvants, such as carriers, solvents and wetting agents, comprises as active ingredient a mixture of
a) a herbicidally effective amount of a compound of formula I according to claim 1 and
c) an amount, effective for herbicide antagonism, of a compound selected from the compound of formula 3.1

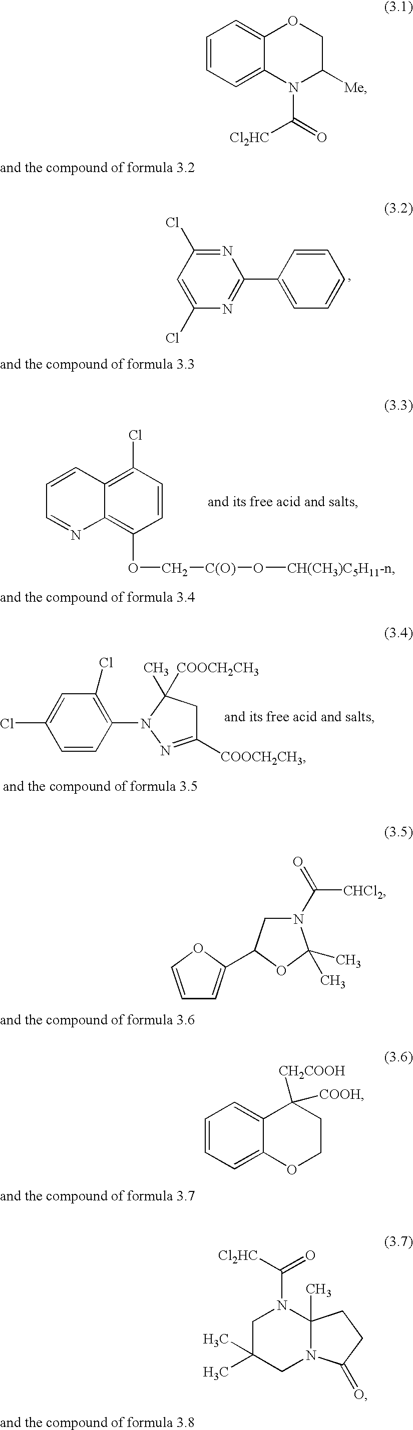

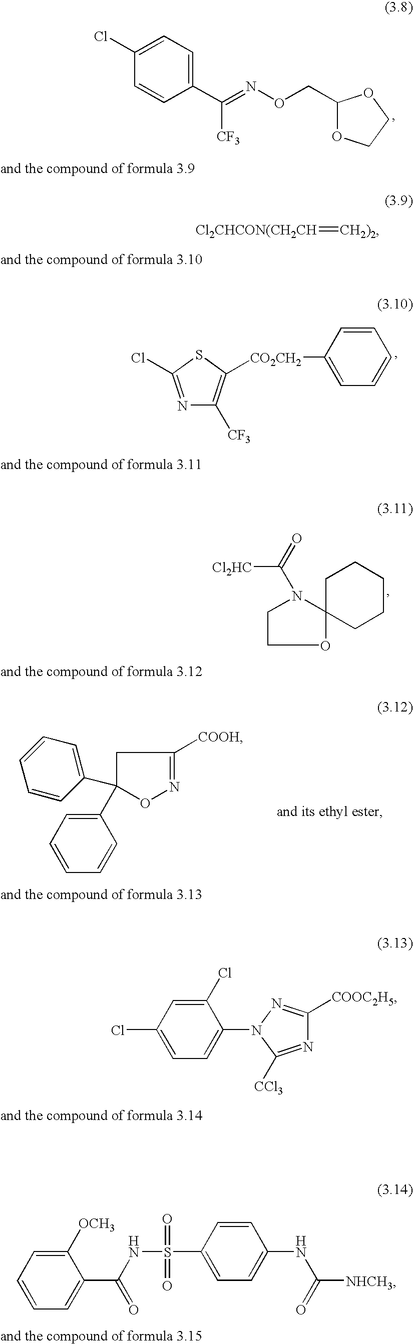

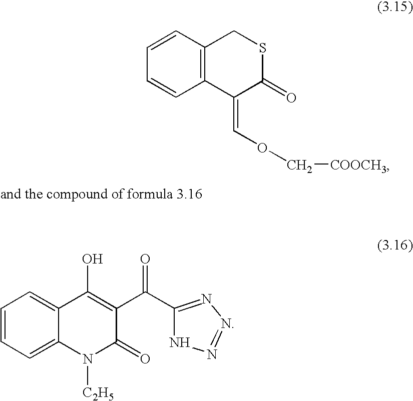

10. A method for the selective control of weeds and grasses in crops of useful plants, which comprises treating the useful plants, seeds or cuttings thereof, or the area of cultivation thereof, with an amount, effective for herbicide synergism, of a composition according to claim 9.
